(19) United States
(12) Patent Application Publication
(10) Pub. No.: US 2026/0303705 A1
(43) Pub. Date: Oct. 1, 2026

(54) CONTEXTUAL ARTIFICIAL INTELLIGENCE (AI) BASED ROUTING OF NETWORK COMMUNICATION

(71) Applicant: 8x8, Inc., Campbell, CA (US)

(72) Inventors: Dragos Cacuci, Campbell, CA (US); Arthur Henning, Campbell, CA (US); Jared Smith-Mickelson, Campbell, CA (US); Bryan Martin, Campbell, CA (US); Natalia Zincenco, Campbell, CA (US); Hunter Middleton, Campbell, CA (US); Dhwani Soni, Campbell, CA (US)

(73) Assignee: 8x8, Inc., Campbell, CA (US)

(21) Appl. No.: 19/254,885

(22) Filed: Jun. 30, 2025

Related U.S. Application Data
(60) Provisional application No. 63/781,312, filed on Mar. 31, 2025.

(51) Int. Cl. H04L 67/63; G06Q 30/015

(52) U.S. Cl. CPC H04L 67/63; G06Q 30/015

(57) ABSTRACT

A system integrated with a communication platform for assisting a routing of a communication, includes: a processing unit configured to obtain context information indicating a context of the communication, and to determine routing information based on the context information for assisting routing of the communication; wherein the processing unit comprises a user interface generator configured to provide a user interface, the user interface configured to present the routing information to a user, wherein the user interface is configured to receive a user input to influence the routing of the communication to an agent.

### RELATED APPLICATION DATA

This application claims priority to, and the benefit of, U.S. Provisional Patent Application No. 63/781,312 filed on Mar. 31, 2025. The entire disclosure of the above application is expressly incorporated by reference herein.

### FIELD

The field of the subject disclosure relates to routing of network communication, and systems and methods for contextual routing of network communication using artificial intelligence.

### BACKGROUND

Customer support issues commonly arise in large product and services organizations, especially with regard to software services implemented via a software communications platform that provides SaaS services, telecom, etc., connected with hardware. Issues can arise at any point (end-to-end) from product sales, implementation/provisioning, account management, product and device support as well as service availability, service upgrades, service renewals/terminations, etc.

In some cases, it can be difficult to make sure issues are routed to the appropriate department/person given the full context of the situation (current interaction analysis and time, sentiment analysis, historical context, etc.). Also, not all agents are created equal. For example, some agents handling network traffic communication may have more advance functionalities or features compared to others. Also, some agents may be more equipped to handle a certain communication than others. Thus, if a customer or user is routed to the first available agent (i.e., based on agent's availability), then the customer may be routed to an agent who is unqualified to solve the specific issue for the customer. In such scenario, the customer or user may be later transferred to another available agent, who may still be unsuccessful in addressing the issue for the customer. In the worst case scenario, when the customer or user feels that he/she is not receiving the required support, the customer or user may end the call/chat. All of this leads to inefficiency and wasteful uses of resources, including hardware/computing resources/devices used to support inefficient routing.

Accordingly, it would be desirable to provide a new technique of routing network communication to desirable agents (e.g., customer support agent). One or more embodiments disclosed herein relate to a communications platform implementation configured to provide a unique practical application for contextual routing of communication.

### SUMMARY

A routing management system configured to assist a routing of communication participated by a customer, and associated method, are described herein. The routing management system may be integrated with a communication platform, such as a Unified Communications as a Service (UCaas) platform, a Control Center as a Service (CCaas) platform, a Communications Platform as a Service (CPaas), or any of other cloud-based communication platform. In one implementation, the routing management system is integrated with a communication platform of a contact center, thereby leveraging unique set of big data from communications platform and endpoints of the contact center to provide real-time (or near real-time) context for assisting routing of the communication. Endpoints of the contact center are not limited to one type, and may be device-specific signal data, user-specific signal data, application-specific data service-specific data, etc. In some cases, artificial intelligence (AI) may be utilized to build a fully customized response at scale based on the services provided by a contact center. The customized response may include answer to customer's query, routing suggestions to rout the current communication to different alternative agents who can handle matter for the customer, and predictive insights to help guide the conversation. The response may be based on the exchange of information in the current communication with the customer, but may also be based on past interactions (positive or negative) between other customers and agents.

The routing management system described herein may provide a user interface integrated into app/service (e.g., agent workspace) to provide a user (e.g., current agent, supervisor of the communication, routing operator, etc.) with routing suggestions and insights to route a current communication to one of a plurality of different agents that can handle the customer's need. In alternative implementations described herein, the alternative routing suggestions and insights may be provided by the routing management system to the customer (a participant of the communication) as a self-service feature for the customer. In such cases, the customer himself/herself may decide how to advance the communication, such as by selecting one of the routing suggestions to route the communication to one of the suggested agents. A user interface having one or more graphical user interface (GUI) elements may be provided to allow the user (e.g., agent, customer, supervisor of the communication, etc.) to decide how to advance a communication. By means of non-limiting examples, the user may utilize the GUI element(s) of the user interface to choose (1) providing an answer to the customer without agent involvement, (2) routing the communication to one of the suggested agents to handle matter for the customer, (3) routing the communication to a suggested AI bot to allow the AI bot to handle the matter for the customer, (4) scheduling a follow up with an agent at a later time, (5) option (1) in combination with option (2), (4) option (1) in combination with option (3).

In addition, customer profiles can be created by the routing management system to help provide contextual insights regarding different customers, such as interactions preferences, satisfaction scores, topics of interests, etc. Agent profiles can also be created, managed, and compared for purposes of recommending agents to resolve issue for a customer in a communication based on customer query, context, agents' functionalities, or any combination of the foregoing. The agent profiles may be for human agents, bot agents, or combination of both. The customer profiles and the agent profiles may be utilized to generate routing suggestions to route the current communication to different alternative agents.

Furthermore, an example of the routing management system described herein may provide an agent with in-app update and data insights after the communication is completed or during a communication. The routing management system may provide a GUI element for allowing the agent to take actions to affect future workflows so that future communications can be improved. In some cases, the routing management system is implemented in, or is integrated with, an omni-channel platform of the contact center. Accordingly, datapoints associated with different services across the contact center, and meta data regarding the datapoints, can be leveraged to provide updates and insights across different services (e.g., features, functionalities), and to generate suggestions of actions for improving process flow of future communications. In some cases, the contact center may include a Customer Interaction Data Platform (CIDP) implementing the routing management system or to which the routing management system is integrated. The CIDP may be utilized to access the datapoints and meta data of the datapoints associated with different services across the contact center.

A system integrated with a communication platform for assisting a routing of a communication, includes: a processing unit configured to obtain context information indicating a context of the communication, and to determine routing information based on the context information for assisting routing of the communication; wherein the processing unit comprises a user interface generator configured to provide a user interface, the user interface configured to present the routing information to a user, wherein the user interface is configured to receive a user input to influence the routing of the communication to an agent.

Optionally, the system is configured to provision a routing output to cause the courting of the communication to the agent based on the user input.

Optionally, the agent is a bot.

Optionally, the agent is a human agent.

Optionally, the communication is a network conversation between a customer and a chatbot.

Optionally, the communication is a network conversation between a customer and a human agent.

Optionally, the routing information comprises a routing suggestion for the communication.

Optionally, the routing suggestion for the communication comprises an agent-to-agent transfer recommendation, an agent-to-bot transfer recommendation, a bot-to-agent transfer recommendation, or a bot-to-bot transfer recommendation.

Optionally, the routing suggestion is based on the communication and the context of the communication.

Optionally, the routing suggestion is based on a customer profile of a participant of the communication.

Optionally, the routing suggestion is based on an agent profile of the agent.

Optionally, the routing suggestion for the communication comprises a recommendation to transfer from a first agent to a second agent, wherein the first agent and the second agent are in a same department, in different respective departments, or in different respective companies.

Optionally, the routing suggestion for the communication comprises a recommendation to transfer the communication to a bot, wherein the bot is trained for a specific topic, is trained for a specific department, or is trained based on knowledge of a specific person.

Optionally, the specific person is a sales executive of a company having deal-specific insights gained from years of experience, and wherein the bot is trained based on the deal-specific insights.

Optionally, the routing suggestion for the communication comprises a recommendation to transfer the communication to a general AI-bot implemented across different types of data at a communication platform of a contact center.

Optionally, the routing information comprises a first routing suggestion.

Optionally, the routing information also comprises a first identity of a first agent associated with the first routing suggestion.

Optionally, the routing information also comprises first agent information indicating an expertise of the first agent, an experience of the first agent, a success rate of the first agent, an availability of the first agent, a location of the first agent, a language spoken by the first agent, a wait time for the first agent, or any combination of two or more of any of the foregoing.

Optionally, the routing information also comprises a second routing suggestion.

Optionally, the routing information also comprises a first identity of a first agent associated with the first routing suggestion, and a second identity of a second agent associated with the second routing suggestion.

Optionally, the routing information also comprises a ranking of the first routing suggestion and the second routing suggestion.

Optionally, the ranking is based on wait times for different agents associated respectively with the first routing suggestion and the second routing suggestion.

Optionally, the ranking is based on feedback scores of different agents associated respectively with the first routing suggestion and the second routing suggestion.

Optionally, the system further includes a customer database storing a customer profile, and wherein the context information comprises or is based on one or more items in the customer profile.

Optionally, one or more items in the customer profile comprise a preference of a customer, current sentiment of the customer, past communication history of the customer, satisfaction score, a language spoken by the customer, a location of the customer, an age of the customer, one or more subjects of interest of the customer, or two or more of any of the foregoing.

Optionally, the system further includes an agent database storing an agent profile, and wherein the context information comprises or is based on one or more items in the agent profile.

Optionally, the one or more items in the agent profile comprise agent information indicating an expertise of the agent, an experience of the agent, a strength of the agent, a weakness of the agent, an interaction success rate of the agent, an interaction failure rate of the agent, or any combination of two or more of any of the foregoing.

Optionally, the user is a participant of the communication, and wherein the user interface is configured to present the routing information to the participant of the communication.

Optionally, the user interface generator is configured to provide the user interface to the participant of the communication as a self-service feature.

Optionally, the user interface generator is configured to provide the user interface as a part or, or in association with, a communication interface that allows the user to communicate with a chatbot or a human agent.

Optionally, the user is a routing operator, and wherein the user interface is configured to present the routing information to the routing operator.

Optionally, the user is a supervisor of the communication, and wherein the user interface is configured to present the routing information to the supervisor.

Optionally, the user interface includes a follow-up feature for allowing the user to schedule a follow-up communication at a future time.

Optionally, the system is configured to access a customer profile and an agent profile, and to schedule the follow-up communication based on the customer profile and the agent profile.

Optionally, the system is configured to provide a follow-up message, a follow-up call, or a follow-up email, as the follow-up communication.

Optionally, the system is configured to create customized prompts for context-specific interaction in the communication.

Optionally, the system is configured to provide the customized prompts to the user and/or to a current agent involved in the communication.

Optionally, the communication platform is a component of a contact center.

Optionally, the communication platform is an omni-channel communication platform of the contact center, and wherein the processing unit comprises a neural network model trained based on data points across the omni-channel platform.

Optionally, the data points are associated with data sources integrated with the omni-channel communication platform of the contact center.

Optionally, the processing unit comprises a neural network model implemented as a part of a contact center.

Optionally, the neural network model is trained to analyze data endpoints of contact center to generate a customized response.

Optionally, the endpoints data comprise device-specific data, user-specific data, application-specific data, service-specific data, third-party specific data, or any combination of two or more of the foregoing.

Optionally, the customized response comprises a bot response.

Optionally, the neural network model comprises a bot trained for a specific topic, trained for a specific department, or trained based on knowledge of a specific person.

Optionally, the specific person is a sales executive of a company having deal-specific insights gained from years of experience, and wherein the bot is trained based on the deal-specific insights.

Optionally, the neural network model is trained to analyze data endpoints of contact center to generate a routing suggestion for the communication.

Optionally, the neural network model is configured to generate a report based on endpoints of data sources integrated with a contact center.

Optionally, the report comprises a communication summary, a meeting summary, a text-to-speech file, a translation, a transcription, a user profile, an agent profile, or two or more of any combination of the foregoing.

Optionally, the neural network model is trained based on past interactions between customers and agents.

Optionally, the past interactions comprise positive past interactions, negative past interactions, or a combination of both the positive past interactions and the negative past interactions.

Optionally, the processing unit is configured to utilize the neural network model for interactive routing of the communication for matter handling.

Optionally, the interactive routing is based on a health score.

Optionally, the health score is based on an experience with a specific customer, and wherein the processing unit is configured to route the communication to a specific customer support manager based on the health score.

Optionally, the health score is matter specific, customer specific, agent specific, organization specific, or any combination of two or more of the foregoing.

Optionally, the health score is an overall score regarding the communication, regarding a specific agent, or regarding a communication platform providing the communication.

Optionally, the communication platform is configured to assist matter handling for one or more customers, and wherein the health score is a real-time or near real-time evaluation of performance of the communication platform.

Optionally, the neural network model is trained based on a skillset of an agent.

Optionally, the agent comprises an Unified Communication (UC) agent, a Contact Center (CC) agent, a Communication Platform as a Service (CPaaS) agent, or any of other cloud-based platform agents.

Optionally, the network model is based on sales profiles, agent profiles, CSM profiles, product profiles, engineering profiles, legal profiles, or two or more of any of the foregoing.

Optionally, the processing unit or the neural network model of the processing unit is configured to provide a response to a customer as a part of the communication, and wherein the processing unit or the neural network is also configured to provide a confidence score that the response is accurate, a source attribution for the response, a confidence score that the response satisfies a customer inquiry, a confidence score that response is complete, a likelihood of a follow-up request associated with the response, a validation of the response, or two or more of any combination of the foregoing.

Optionally, the processing unit or the neural network of the processing unit is configured to provide a predictive insight regarding the communication.

Optionally, the processing unit or the neural network of the processing unit is configured to provide a confidence scoring for a suggested routing to the agent.

A method performed by a system integrated with a communication platform for assisting a routing of a communication, includes: obtaining by a processing unit of the system, context information indicating a context of the communication; determining routing information based on the context information for assisting routing of the communication; providing, by a user interface generator of the system, a user interface; presenting the routing information to a user via the user interface; and receiving a user input via the user interface to influence the routing of the communication to an agent.

Optionally, the method further includes provisioning a routing output to cause the courting of the communication to the agent based on the user input.

Optionally, the agent is a bot.

Optionally, the agent is a human agent.

Optionally, the communication is a network conversation between a customer and a chatbot.

Optionally, the communication is a network conversation between a customer and a human agent.

Optionally, the routing information comprises a routing suggestion for the communication.

Optionally, the routing suggestion for the communication comprises an agent-to-agent transfer recommendation, an agent-to-bot transfer recommendation, a bot-to-agent transfer recommendation, or a bot-to-bot transfer recommendation.

Optionally, the routing suggestion is based on the communication and the context of the communication.

Optionally, the routing suggestion is based on a customer profile of a participant of the communication.

Optionally, the routing suggestion is based on an agent profile of the agent.

Optionally, the routing suggestion for the communication comprises a recommendation to transfer from a first agent to a second agent, wherein the first agent and the second agent are in a same department, in different respective departments, or in different respective companies.

Optionally, the routing suggestion for the communication comprises a recommendation to transfer the communication to a bot, wherein the bot is trained for a specific topic, is trained for a specific department, or is trained based on knowledge of a specific person.

Optionally, the specific person is a sales executive of a company having deal-specific insights gained from years of experience, and wherein the bot is trained based on the deal-specific insights.

Optionally, the routing suggestion for the communication comprises a recommendation to transfer the communication to a general AI-bot implemented across different types of data at a communication platform of a contact center.

Optionally, the routing information comprises a first routing suggestion.

Optionally, the routing information also comprises a first identity of a first agent associated with the first routing suggestion.

Optionally, the routing information also comprises first agent information indicating an expertise of the first agent, an experience of the first agent, a success rate of the first agent, an availability of the first agent, a location of the first agent, a language spoken by the first agent, a wait time for the first agent, or any combination of two or more of any of the foregoing.

Optionally, the routing information also comprises a second routing suggestion.

Optionally, the routing information also comprises a first identity of a first agent associated with the first routing suggestion, and a second identity of a second agent associated with the second routing suggestion.

Optionally, the routing information also comprises a ranking of the first routing suggestion and the second routing suggestion.

Optionally, the ranking is based on wait times for different agents associated respectively with the first routing suggestion and the second routing suggestion.

Optionally, the ranking is based on feedback scores of different agents associated respectively with the first routing suggestion and the second routing suggestion.

Optionally, the method further includes accessing a customer database storing a customer profile, and wherein the context information comprises or is based on one or more items in the customer profile.

Optionally, one or more items in the customer profile comprise a preference of a customer, current sentiment of the customer, past communication history of the customer, satisfaction score, a language spoken by the customer, a location of the customer, an age of the customer, one or more subjects of interest of the customer, or two or more of any of the foregoing.

Optionally, the method further includes accessing an agent database storing an agent profile, and wherein the context information comprises or is based on one or more items in the agent profile.

Optionally, the one or more items in the agent profile comprise agent information indicating an expertise of the agent, an experience of the agent, a strength of the agent, a weakness of the agent, an interaction success rate of the agent, an interaction failure rate of the agent, or any combination of two or more of any of the foregoing.

Optionally, the user is a participant of the communication, and wherein the user interface is configured to present the routing information to the participant of the communication.

Optionally, the user interface generator is configured to provide the user interface to the participant of the communication as a self-service feature.

Optionally, the user interface generator is configured to provide the user interface as a part or, or in association with, a communication interface that allows the user to communicate with a chatbot or a human agent.

Optionally, the user is a routing operator, and wherein the user interface is configured to present the routing information to the routing operator.

Optionally, the user is a supervisor of the communication, and wherein the user interface is configured to present the routing information to the supervisor.

Optionally, the user interface includes a follow-up feature for allowing the user to schedule a follow-up communication at a future time.

Optionally, the method further includes accessing a customer profile and an agent profile, and scheduling the follow-up communication based on the customer profile and the agent profile.

Optionally, the method further includes providing a follow-up message, a follow-up call, or a follow-up email, as the follow-up communication.

Optionally, the method further includes creating customized prompts for context-specific interaction in the communication.

Optionally, the method further includes providing the customized prompts to the user and/or to a current agent involved in the communication.

Optionally, the communication platform is a component of a contact center.

Optionally, the communication platform is an omni-channel communication platform of the contact center, and wherein the processing unit comprises a neural network model trained based on data points across the omni-channel platform.

Optionally, the data points are associated with data sources integrated with the omni-channel communication platform of the contact center.

Optionally, the processing unit comprises a neural network model implemented as a part of a contact center.

Optionally, the neural network model is trained to analyze data endpoints of contact center to generate a customized response, and wherein the method comprises providing the customized response.

Optionally, the endpoints data comprise device-specific data, user-specific data, application-specific data, service-specific data, third-party specific data, or any combination of two or more of the foregoing.

Optionally, the customized response comprises a bot response.

Optionally, the neural network model comprises a bot trained for a specific topic, trained for a specific department, or trained based on knowledge of a specific person.

Optionally, the specific person is a sales executive of a company having deal-specific insights gained from years of experience, and wherein the bot is trained based on the deal-specific insights.

Optionally, the neural network model is trained to analyze data endpoints of contact center to generate a routing suggestion for the communication, and wherein the method comprises providing the routing suggestion.

Optionally, the neural network model is configured to generate a report based on endpoints of data sources integrated with a contact center, and wherein the method comprises providing the report.

Optionally, the report comprises a communication summary, a meeting summary, a text-to-speech file, a translation, a transcription, a user profile, an agent profile, or two or more of any combination of the foregoing.

Optionally, the neural network model is trained based on past interactions between customers and agents.

Optionally, the past interactions comprise positive past interactions, negative past interactions, or a combination of both the positive past interactions and the negative past interactions.

Optionally, the method further includes providing, by the processing unit or the neural network model of the processing unit, an interactive routing of the communication for matter handling.

Optionally, the interactive routing is based on a health score.

Optionally, the health score is based on an experience with a specific customer, and wherein the processing unit is configured to route the communication to a specific customer support manager based on the health score.

Optionally, the health score is matter specific, customer specific, agent specific, organization specific, or any combination of two or more of the foregoing.

Optionally, the health score is an overall score regarding the communication, regarding a specific agent, or regarding a communication platform providing the communication.

Optionally, the communication platform is configured to assist matter handling for one or more customers, and wherein the health score is a real-time or near real-time evaluation of performance of the communication platform.

Optionally, the neural network model is trained based on a skillset of an agent.

Optionally, the agent comprises an Unified Communication (UC) agent, a Contact Center (CC) agent, a Communication Platform as a Service (CPaaS) agent, or any of other cloud-based platform agents.

Optionally, the network model is based on sales profiles, agent profiles, CSM profiles, product profiles, engineering profiles, legal profiles, or two or more of any of the foregoing.

Optionally, the method further includes providing, by the processing unit or the neural network model of the processing unit, a response to a customer as a part of the communication; wherein the method further comprises providing, by the processing unit or the neural network, a confidence score that the response is accurate, a source attribution for the response, a confidence score that the response satisfies a customer inquiry, a confidence score that response is complete, a likelihood of a follow-up request associated with the response, a validation of the response, or two or more of any combination of the foregoing.

Optionally, the method further includes providing, by the processing unit or the neural network of the processing unit, a predictive insight regarding the communication.

Optionally, the method further includes providing, by the processing unit or the neural network of the processing unit, a confidence scoring for a suggested routing to the agent.

A computer-product includes a non-transitory medium storing instructions, wherein an execution of the instructions will cause a method to be performed by a system integrated with a communication platform for assisting a routing of a communication, the method comprising: obtaining by a processing unit of the system, context information indicating a context of the communication; determining routing information based on the context information for assisting routing of the communication; providing, by a user interface generator of the system, a user interface; presenting the routing information to a user via the user interface; and receiving a user input via the user interface to influence the routing of the communication to an agent.

A system integrated with a communication platform for assisting a routing of a communication, includes: a processing unit configured to obtain context information indicating a context of the communication, and determine routing information based on the context information for assisting routing of the communication, wherein the routing information comprises a first routing suggestion for the communication; wherein system also comprises a user interface generator configured to provide a user interface, the user interface configured to present the routing information to a user, wherein the user interface is configured to receive a user input to influence the routing of the communication to an agent.

Optionally, the first routing suggestion for the communication comprises an agent-to-agent transfer recommendation, an agent-to-bot transfer recommendation, a bot-to-agent transfer recommendation, or a bot-to-bot transfer recommendation.

Optionally, the first routing suggestion is based on a customer profile of a participant of the communication, and/or an agent profile of the agent.

Optionally, the first routing suggestion for the communication comprises a recommendation to transfer the communication to a bot, wherein the bot is trained for a specific topic, is trained for a specific department, or is trained based on knowledge of a specific person.

Optionally, the specific person is a sales executive of a company having deal-specific insights gained from years of experience, and wherein the bot is trained based on the deal-specific insights.

Optionally, the first routing suggestion for the communication comprises a recommendation to transfer the communication to a general AI-bot implemented across different types of data at a communication platform of a contact center.

Optionally, the routing information also comprises a first identity of a first agent associated with the first routing suggestion.

Optionally, the routing information also comprises first agent information indicating an expertise of the first agent, an experience of the first agent, a success rate of the first agent, an availability of the first agent, a location of the first agent, a language spoken by the first agent, a wait time for the first agent, or any combination of two or more of any of the foregoing.

Optionally, the routing information also comprises a second routing suggestion.

Optionally, the routing information also comprises a first identity of a first agent associated with the first routing suggestion, and a second identity of a second agent associated with the second routing suggestion.

Optionally, the routing information also comprises a ranking of the first routing suggestion and the second routing suggestion.

Optionally, the ranking is based on wait times for different agents associated respectively with the first routing suggestion and the second routing suggestion.

Optionally, the ranking is based on feedback scores of different agents associated respectively with the first routing suggestion and the second routing suggestion.

Optionally, the system further includes a customer database storing a customer profile, wherein the context information comprises or is based on one or more items in the customer profile, and wherein one or more items in the customer profile comprise a preference of a customer, current sentiment of the customer, past communication history of the customer, satisfaction score, a language spoken by the customer, a location of the customer, an age of the customer, one or more subjects of interest of the customer, or two or more of any of the foregoing.

Optionally, the system further includes an agent database storing an agent profile, wherein the context information comprises or is based on one or more items in the agent profile, and wherein the one or more items in the agent profile comprise agent information indicating an expertise of the agent, an experience of the agent, a strength of the agent, a weakness of the agent, an interaction success rate of the agent, an interaction failure rate of the agent, or any combination of two or more of any of the foregoing.

Optionally, the user is a participant of the communication, and wherein the user interface is configured to present the routing information to the participant of the communication.

Optionally, the user interface includes a follow-up feature for allowing the user to schedule a follow-up communication at a future time, and wherein the system is configured to access a customer profile and an agent profile, and to schedule the follow-up communication based on the customer profile and the agent profile.

Optionally, the communication platform is an omni-channel communication platform of a contact center, and wherein the processing unit comprises a neural network model trained based on data points across the omni-channel platform, wherein the data points are associated with data sources integrated with the omni-channel communication platform of the contact center.

Optionally, the system may include communications circuitry communicatively integrated with computer processing circuitry to provide one or more features described herein. For example, in some cases, the system may include or may integrate with a set of one or more servers (e.g., communication provider servers) configured to provide data-communications service(s) to sets of endpoint devices respectively associated with remotely-situated clients, the data-communications service(s) being established via channels of respective networks accessible to one or more of the endpoint devices through the server(s). The system may be integrated with, or may be configured to communicate with, a communication platform (e.g., that of a contact center) configured to route an incoming call involving one of the endpoint devices.

A method performed by a system integrated with a communication platform for assisting a routing of a communication, includes: obtaining, by a processing unit of the system, context information indicating a context of the communication; determining routing information based on the context information for assisting routing of the communication, wherein the routing information comprises a first routing suggestion for the communication; providing, by a user interface generator of the system, a user interface; presenting the routing information to a user via the user interface; and receiving a user input via the user interface to influence the routing of the communication to an agent.

A computer-product includes a non-transitory medium storing instructions, wherein an execution of the instructions will cause a method to be performed by a system integrated with a communication platform for assisting a routing of a communication, the method comprising: obtaining, by a processing unit of the system, context information indicating a context of the communication; determining routing information based on the context information for assisting routing of the communication, wherein the routing information comprises a first routing suggestion for the communication; providing, by a user interface generator of the system, a user interface; presenting the routing information to a user via the user interface; and receiving a user input via the user interface to influence the routing of the communication to an agent.

A system integrated with a communication platform for assisting a routing of a communication, includes: a processing unit configured to obtain context information indicating a context of the communication, and to determine routing information based on the context information for assisting routing of the communication; wherein the processing unit comprises a neural network model implemented as a part of a contact center or configured to communicate with the contact center, wherein the neural network model is trained based on data endpoints of the contact center, and is configured to provide the routing information to assist the routing of the communication based on the context information.

Optionally, the endpoints data comprise device-specific data, user-specific data, application-specific data, service-specific data, third-party specific data, or any combination of two or more of the foregoing.

Optionally, the neural network model or another neural network model of the system comprises a bot trained for a specific topic, trained for a specific department, or trained based on knowledge of a specific person.

Optionally, the specific person is a sales executive of a company having deal-specific insights gained from years of experience, and wherein the bot is trained based on the deal-specific insights.

Optionally, the routing information comprises a routing suggestion, and wherein the neural network model is configured to generate the routing suggestion for the communication.

Optionally, the neural network model is trained based on past interactions between customers and agents.

Optionally, the past interactions comprise positive past interactions, negative past interactions, or a combination of both the positive past interactions and the negative past interactions.

Optionally, the system is configured to utilize the neural network model for interactive routing of the communication for matter handling.

Optionally, the interactive routing is based on a health score.

Optionally, the health score is based on an experience with a specific customer, and wherein the processing unit is configured to cause the communication to be routed to a specific customer support manager based on the health score.

Optionally, the health score is matter specific, customer specific, agent specific, organization specific, or any combination of two or more of the foregoing.

Optionally, the health score is an overall score regarding the communication, regarding a specific agent, or regarding the communication platform providing the communication.

Optionally, the communication platform is configured to assist matter handling for one or more customers, and wherein the health score is a real-time or near real-time evaluation of performance of the communication platform.

Optionally, the neural network model is trained based on a skillset of an agent.

Optionally, the agent comprises an Unified Communication (UC) agent, a Contact Center (CC) agent, a Communication Platform as a Service (CPaaS) agent, or any of other cloud-based platform agents.

Optionally, the processing unit is configured to provide a response to a customer as a part of the communication, and wherein the processing unit is also configured to provide a confidence score that the response is accurate, a source attribution for the response, a confidence score that the response satisfies a customer inquiry, a confidence score that response is complete, a likelihood of a follow-up request associated with the response, a validation of the response, or two or more of any combination of the foregoing.

Optionally, the routing information comprises a suggested routing to an agent, and wherein the processing unit is configured to provide a confidence scoring for the suggested routing to the agent.

Optionally, the system also comprises a user interface generator configured to provide a user interface, the user interface configured to present the routing information to a user, wherein the user interface is configured to receive a user input to influence the routing of the communication to an agent.

Optionally, the system may include communications circuitry communicatively integrated with computer processing circuitry to provide one or more features described herein. For example, in some cases, the system may include or may integrate with a set of one or more servers (e.g., communication provider servers) configured to provide data-communications service(s) to sets of endpoint devices respectively associated with remotely-situated clients, the data-communications service(s) being established via channels of respective networks accessible to one or more of the endpoint devices through the server(s). The system may be integrated with, or may be configured to communicate with, a communication platform (e.g., that of a contact center) configured to route an incoming call involving one of the endpoint devices.

A method performed by a system integrated with a communication platform for assisting a routing of a communication, includes: obtaining, by a processing unit of the system, context information indicating a context of the communication; determining, by the processing unit, routing information based on the context information for assisting routing of the communication; wherein the processing unit comprises a neural network model implemented as a part of a contact center or configured to communicate with the contact center, wherein the neural network model is trained based on data endpoints of the contact center, and is configured to provide the routing information to assist the routing of the communication based on the context information.

A computer-product includes a non-transitory medium storing instructions, wherein an execution of the instructions will cause a method to be performed by a system integrated with a communication platform for assisting a routing of a communication, the method comprising: obtaining, by a processing unit of the system, context information indicating a context of the communication; determining, by the processing unit of the system, routing information based on the context information for assisting routing of the communication; wherein the processing unit comprises a neural network model implemented as a part of a contact center or configured to communicate with the contact center, wherein the neural network model is trained based on data endpoints of the contact center, and is configured to provide the routing information to assist the routing of the communication based on the context information.

Other and further aspects and features will be evident from reading the following detailed description.

### BRIEF DESCRIPTION OF THE DRAWINGS

The drawings illustrate the design and utility of embodiments, in which similar elements are referred to by common reference numerals. In order to better appreciate how advantages and objects are obtained, a more particular description of the embodiments will be described with reference to the accompanying drawings. Understanding that these drawings depict only exemplary embodiments and are not therefore to be considered limiting in the scope of the claimed invention.

FIG. 1 illustrates an example of a communication system having a contact center, which includes a routing management system.

FIG. 2 illustrates an example of a Customer Interaction Data Platform (CIDP) implemented in the contact center of FIG. 1.

FIG. 3 illustrates an example of data sources correlated by the CIDP of FIG. 2 with services or features of destinations.

FIG. 4 illustrates an example of artificial intelligence (AI) building blocks for a communication platform implemented in the contact center of FIG. 1.

FIG. 5 illustrates an example or a user interface providing contextual information for intelligent routing of network communication.

FIG. 6 illustrates another example or a user interface providing contextual information for intelligent routing of network communication.

FIG. 7 illustrates an example of a customer profile.

FIG. 8 illustrates an example of an agent profile.

FIG. 9 illustrates an example of a user interface presented at an agent workspace, particularly showing a real-time notification that a customer satisfaction (CSAT) score is dropping.

FIG. 10 illustrates the user interface of FIG. 9, particularly showing the user interface displaying contextual data insights, which provide context for the dropping of the CSAT score.

FIG. 11 illustrates a user interface providing a list of communication related to the contextual data insights of FIG. 10.

FIG. 12 illustrates a user interface presenting a timeline of events of an interaction in response to a user selecting one of the communications in the list of communication of FIG. 11.

FIG. 13 illustrates a user interface presenting a suggestion of actions for improving workflow, and a graphical user interface (GUI) element for allowing a user to accept the suggestion of actions.

FIG. 14 illustrates the user interface of FIG. 9, particularly showing an improvement of the CSAT score.

FIG. 15 illustrates a method in accordance with some embodiments.

FIG. 16 illustrates a specialized processing system in accordance with some embodiments.

### DESCRIPTION OF THE EMBODIMENTS

Various embodiments are described hereinafter with reference to the figures. It should be noted that elements of similar structures or functions are represented by like reference numerals throughout the figures. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages of the invention shown. An aspect or an advantage described in conjunction with a particular embodiment is not necessarily limited to that embodiment and can be practiced in any other embodiments even if not so illustrated or if not so explicitly described.

Non-limiting examples of the present disclosure may be implementable as processing improvements for stand-alone applications or services, which can also be integrated into software computing platforms (“software platforms”). As software data platforms have layers of complexity, technical problems identified herein can be amplified in such implementations which further illustrates the technical advantages presented in the present disclosure. As such, some examples of the present disclosure may be provided in connection with a software platform such as a software communications platform. An exemplary software communications platform provides digital tools and services that enable real-time (or near real-time) information sharing and collaboration amongst users. An example of a software communications platform may be a cloud-based communications platform (cloud-based platform implementation) such as 8×8 Work® made available by 8×8, Inc. (e.g., additional supporting documentation available at http://www.8×8.com), among other examples.

An exemplary software communications platform may include any technology described herein as “cloud-based platform implementation” individually or collectively. In one example, an exemplary software communications platform may comprise but is not limited to a combination of UCaaS, CCaaS, CPaaS features and functionalities, web services, and connected websites, administrative portals/consoles, connected to system infrastructure including phone systems hosted remotely by servers and accessible via the internet. An exemplary software communications platform can uniquely generate and manage contextual data from components and users thereof, which can then be leveraged cross-platform and further with third-party integrations services, platforms, (e.g., including integrations via API) to provide a rich and contextual omni-channel user experience (e.g., across a plurality of communication channels including voice, electronic meetings, chat, email, messaging, digital messaging, social media) that is accessible through an adapted GUI. An adapted GUI of a software communications platform may be configured and presented as a single unified workspace but can also be represented in via a plurality of GUI workspaces, collapsible and expandable, including break-out GUI functionality to help manage control over communications across different communication channels (omni-channel). Non-limiting examples of features and functionalities of an exemplary software communications platform comprise: omni-channel communication functionality; bot integrations including conversational chatbots (including AI/ML integrations); workforce management (e.g., supervisory management of users such as agents, enterprise resource planning); data analytics (including user-specific, device-specific, software service-specific such as UCaaS or CCaaS, and/or aggregated); ML/AI integrations for data processing, analysis and augmentation including query/response capabilities, translation, transcription, summarization, sentiment and/or biometric analysis, data insight generation, and generation of recommendations or automation of actions within platform; reporting/report generation; customer relationship management (CRM) tools; device management (e.g., phones including both physical phone devices and softphones, PBX, phone numbers, porting, etc.); issue management including support and help desk ticketing management; transaction processing (including payment transactions); billing management; administrative management control including administrative console apps/services to enablement management of users via user profiles, device profiles; phone systems; works groups, ring groups, call queues, group paging, overhead paging, barge-monitor-whisper); IVR; call routing and distribution; call recording functionality; data storage (e.g., including control over hot and cold storage); phone dialers; conversation management including messaging via chat (individual and group), SMS/MMS, including messaging campaigns, website management, and management of service availability, among other examples.

Non-limiting examples of technical advantages provided based on the one or more techniques described herein, may include, but are not limited to: a routing management system configured to obtain context of a communication, and to determine routing information based on the context of the communication for assisting routing of the communication. The routing management system may provide predictive insights regarding a communication to help guide a routing of the communication to one or more agents for matter handling for a customer. The routing information may include routing suggestion providing insights regarding different agents to which the communication can be routed. The routing information may be provided to a supervisor of the communication, who can then provide user input via a user interface to influence the routing of the communication. Alternatively, the routing information may be provided to a customer who is a participant of the communication. The customer may then provide use input via a user interface to influence the routing of the communication in a self-help configuration. The routing information may be based on context of current exchange between participants of the communication, and/or past interactions (positive or negative) between participants of previous communications. In some cases, the platform of the contact center may provide a holistic comprehensive experience to assist agents and customers resolve issues (e.g., technical problems) immediately as well as longer-term. The system and method described herein provide agents with real-time or near real-time recommendations (including data insights and analytics) to help improve communication routing, issue remediation, and matter handling. That may help shape the conversation with the customer, and may allow an agent to tailor responses and to take actions to efficiently resolve a matter. The system and method described herein also provide one or more graphical user interface (GUI) elements configured to allow a user (e.g., a customer or a supervisor of the communication) of the system to take actions, such as scheduling a follow-up action (e.g., follow-up call, follow-up text, follow-up email, etc.), schedule a transfer of the communication, etc. In some cases, the GUI elements may also allow a user to input a pre-prepared or templatized response for the communication. In some cases, the insights of the communication may be utilized by the system to update customer profiles to allow management of customers holistically for future communications with the customers. The routing management system may be implemented as a part of a platform for a contact center. For example, the platform may be a Customer Interaction Data Platform (CIDP) implemented in the contact center. The CIDP may be a part of a communication platform configured to provide or to enable a communication between customers and agents (e.g., chatbot agents and/or human agents). The platform may include one or more machine learning models trained to provide customized responses for customers based on services provided by the contact center, including third-party services of third parties integrated with the contact center. Accordingly, the routing information and the machine learning model(s) may be based on a vast quantity of datapoints at the contact center that are associated with various services. By means of non-limiting examples, such services may be one or more of: omni-channel communication service, bot integrations including conversational chatbots (including AI/ML integrations); workforce management (e.g., supervisory management of users such as agents, enterprise resource planning); data analytics (including user-specific, device-specific, software service-specific such as UCaaS or CCaaS, and/or aggregated); ML/AI integrations for data processing, analysis and augmentation including query/response capabilities, translation, transcription, summarization, sentiment and/or biometric analysis, data insight generation, and generation of recommendations or automation of actions within platform; reporting/report generation; customer relationship management (CRM) tools; device management (e.g., phones including both physical phone devices and softphones, PBX, phone numbers, porting, etc.); issue management including support and help desk ticketing management; transaction processing (including payment transactions); billing management; administrative management control including administrative console apps/services to enablement management of users via user profiles, device profiles; phone systems; works groups, ring groups, call queues, group paging, overhead paging, barge-monitor-whisper); IVR; call routing and distribution; call recording functionality; data storage (e.g., including control over hot and cold storage); phone dialers; conversation management including messaging via chat (individual and group), SMS/MMS, including messaging campaigns, website management, and management of service availability, among other examples.

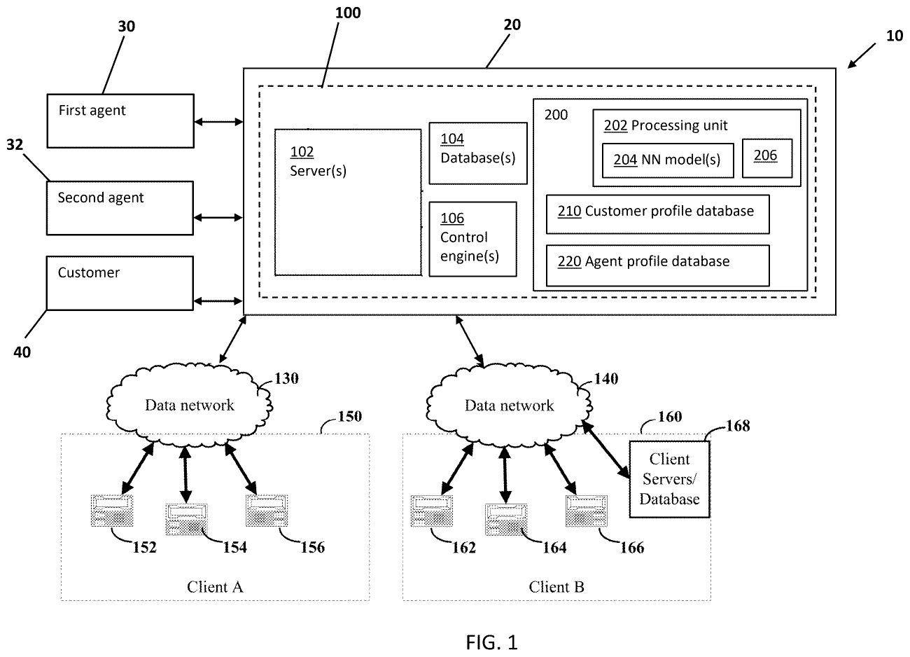

FIG. 1 illustrates an example of a communication system 10 having a contact center 20. The contact center 20 includes a processing system 100 configured to provide one or more features described herein. As shown in the figure, the processing system 100 includes one or more servers 102, one or more databases 104 (e.g., non-transitory medium), and one or more control engines 106. The contact center 20 is configured to provide data communications for a plurality of endpoint devices 152, 154, 156, 162, 164, and 166 connected in one or more data networks 130 and 140. The endpoint devices may include data communications-enabled devices (e.g., IP phones, smart phones, tablets, and/or desktop computers with appropriate data communications software applications) and/or non-data communications endpoint devices (e.g., plain old telephone service (POTS) telephones and cellular-capable devices). Each endpoint device may respectively be associated with an account of a respective client. Endpoint devices may be associated with a particular client account by registering the endpoint device with a particular client account serviced by the contact center 20. Registered devices for each client account may be listed in a respective account settings file (not shown) stored in the database(s) 104. In this example, endpoint devices 152, 154, and 156 are associated within an account 150 for a first client A and endpoint devices 162, 164, and 166 are associated within an account 160 for a second client B. In other cases, any of the endpoint devices may not be associated with any account.

In some cases, the control engine(s) 106 may be one or more client-specific control engine(s) used to facilitate control of endpoint devices associated with a client device. The control of the endpoint devices may be associated with a variety of features including, for example, data communications services such as VoIP calls, audio and/or video conferencing, IPBX exchange servers, packet switching, and traffic management as well as non-data communications services including, but not limited to, website hosting, remote data storage, remote computing services, virtual computing environments. One or more of such features may be provided, for example, by a cloud computing network having one or more servers configurable to provide a data communications system for a plurality of clients. In some cases, the contact center 20 may implement at least a part of such cloud computing network.

The processing system 100 of the contact center 20 includes one or more processing circuits configured to implement the control engine(s) 106, which are configured to adjust the data communications provided for each client account according to a respective set of control directives (e.g., instructions). For instance, the control engine(s) 106 may adjust a manner in which endpoint devices 162, 164, 166 are controlled, and/or a manner of routing of a data communication for a client account, by generating client-specific sets of control data to the server 102. For example, the control engine(s) 106 may generate client-specific sets of control data by processing the respective set of control directives for the account in response to communication event data or other data prompts received at the contact center 20.

Although the control engine(s) 106 is illustrated as a component of the processing system 100 of the contact center 20, the control engine(s) 106 may be implemented in various locations in different embodiments. For example, the control engine(s) 106 for one or more client accounts may be implemented in a central server connected to, or incorporated with, the server(s) 102. Additionally or alternatively, one or more control engine(s) 106 may be implemented by one or more processing circuits maintained by the client (e.g., server/database 168). Similarly, the control directives may be stored locally within the control engines, or stored remotely (e.g., in a centralized database, in a database maintained by the client or a combination thereof).

In some cases, the communication routing and other services for data communications may be provided by the contact center 20 within a cloud service system (e.g., configured to provide virtual features to customers). In such cases, the contact center 20 may include hardware providing the cloud services located in one data center, or a number of different data centers with different physical locations. In some cases, the cloud services may be implemented using SIP servers, media servers, and servers providing other services to both data communications endpoint devices and the users of the data communications endpoint devices. In some instances, the various servers, including both the data communication server(s) and data analytic server(s) discussed herein, may have their functions spread across different physical and logical components. For instance, a cloud-based solution may implement virtual servers that can share common hardware and may be migrated between different underlying hardware. Moreover, in some cases, separate servers or modules may be configured to work together so that they collectively function as a single unified server. Thus, as used in this specification, the term “server” may refer to one or more servers, and may be located at the same facility or in different facilities at different geographical locations.

In some cases, at least one of the server(s) 102 of the contact center 20 may be a data communication server. Such data communication server may use different communication protocols to handle communication functions in different embodiments. For example, such data communication server may use session initiation protocol (SIP) to handle various communication functions (e.g., communication setup and tear down). It should be noted that the server(s) 102 of the contact center 20 is not limited to such example. In other cases, the server(s) 102 may be configured to establish a portion of the communication from the data communications endpoint devices to another data communications endpoint device, or to a gateway. In other cases, the contact center 20 may not include the data communication server. Instead, the contact center 20 may be configured to communicate with the data communication server.

Also, in some cases, at least one of the server(s) 102 of the contact center 20 may be a data analytics server configured to monitor and analyze communication data transmitted between the contact center 20 and endpoint devices, and/or between the contact center 20 and service provider(s) (e.g., service providers 30, 32). For example, a data analytics server may be configured to track communication statistics about various different communication-related parameters, such as communication duration, communication date, communication time of day, called parties, endpoint devices, selected data centers, selected carriers, dropped communications, transferred communications, voicemail access, conferencing features, and others. In other cases, the contact center 20 may not include the data analytics server. Instead, the contact center 20 may be configured to communicate with the data analytics server.

In further cases, the server(s) 102 of the contact center 20 may include a data communication server configured to access communication summary metrics and the data analytics stored in the database(s) 104. For example, a script running the data communications server may parse communication processing XML (CPXML) documents to generate database queries that direct the data communications server to query, or subscribe to, communication length summaries for all communications made to endpoints that are registered to the server. The script may use the information to control how communications are routed as well as how different (customer or provider) services are invoked. In some cases, the server(s) 102 of the contact center 20 may be configured to interface with customer databases, or with third party servers. For instance, a CPXML document stored by in a cloud-based system may identify, based upon a received communication, a Uniform Resource Identifier (URI) that points to customer databases, or to a third-party server. Control directives provided from these servers, for example, in the form of a CPXML document, may be used to specify communication routing, or other functions.

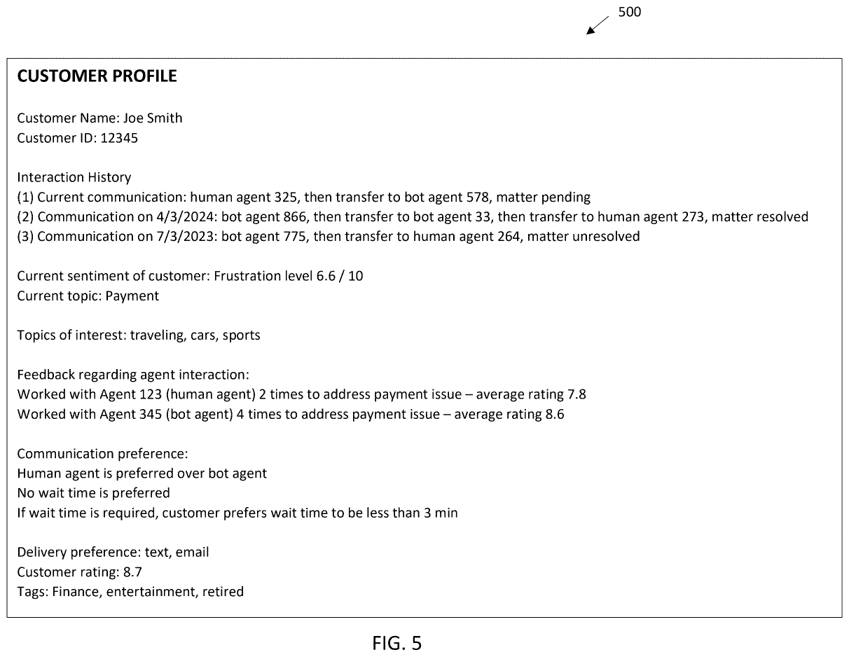

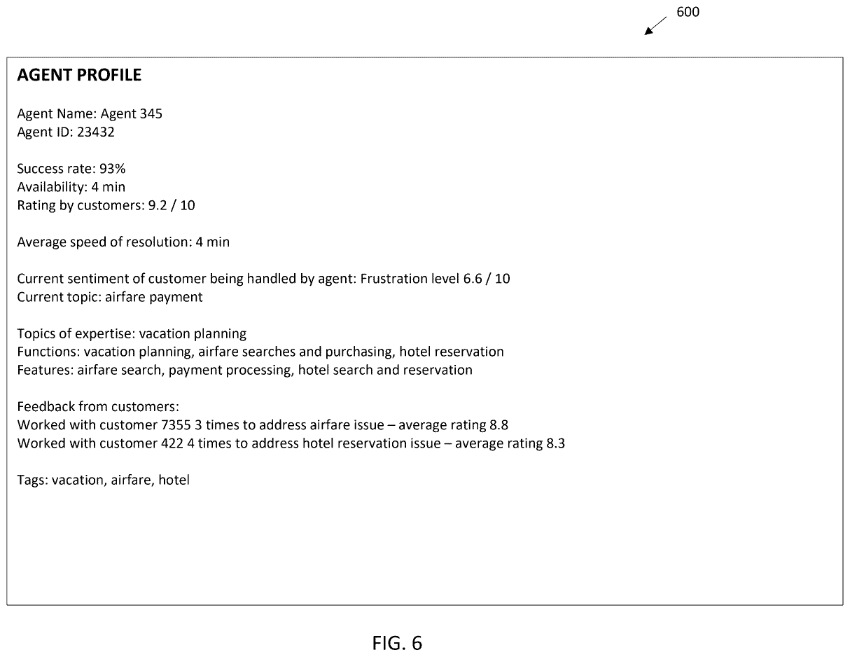

As showing in FIG. 1, the contact center 20 includes a routing management system 200 configured to assist routing of communication for a customer 40 to an agent, such as first agent 30 or second agent 32. The routing management system 200 includes a processing unit 202, a customer profile database 210, and an agent profile database 220. The customer profile database 210 stores customer profiles for different respective customers. The agent profile database 220 stores agent profiles for different respective agents (e.g., first agent 30, second agent 32, etc.). Exemplary customer profile and exemplary agent profile will be described with reference to FIGS. 5-6. The processing unit 202 of the routing management system 200 is configured to obtain a context of a communication between the customer 40 and an agent, and determine routing information to assist a routing of the communication to another agent, such as the first agent 30, or the second agent 32. In some cases, the processing unit 202 of the routing management system 200 is configured to access the customer profile database 210 to retrieve a customer profile for the customer 40, and to determine the routing information based on one or more items in the customer profile. In some cases, the one or more items in the customer profile may be considered as examples of the context of the communication obtained by the processing unit 202. Alternatively or additionally, the processing unit 202 of the routing management system 200 is configured to access the agent profile database 220 to retrieve one or more agent profiles for the customer 40, and to determine the routing information based on one or more items in the agent profile(s). In some cases, the one or more items in the agent profile may be considered as examples of the context of the communication obtained by the processing unit 202.

Each of the agents 30, 32 may be a human agent or a bot agent. In the case in which the agent 30/32 is a human agent, the human agent may be an employee or a contractor of the contact center 20. Alternatively, the human agent may be an employee or a contractor of a third-party service provider, such as a partner of the contact center 20. In such cases, the contact center 20 may communicate with the human agent via a device (e.g., any of the devices 152, 154, 156, 162, 164, 166, etc.). In the case in which the agent 30/32 is a bot agent, the bot agent may be a bot (e.g., generic bot, custom-trained bot, etc.) provided by the contact center 20, or it may be a bot provided by third-party provider, such as a partner of the contact center 20.

As shown in the figure, the routing management system 200 also includes one or more neural network models 204. The neural network model(s) 204 is configured (trained) to provide certain functionality/feature for assisting matter handling involved in the communication with customer 40. Examples of the neural network model(s) 204 will be described below.

The routing management system 200 also includes a user interface generator 206 configured to present routing information for assisting a routing of communication for the customer 40. In some cases, the user interface generator 206 may provide a user interface for presentation in a screen at an agent station. In other cases, the user interface generator 206 may provide a user interface for presentation in a screen at a device of the customer 40. In such cases, the user interface is a self-service feature that allows the customer 40 to influence how the communication is to be routed.

In the illustrated example, the routing management system 200 is illustrated as being a part of the contact center 20. In other cases, the routing management system 200 may be separate from the processing system 100 of the contact center 20. For example, in other cases, the routing management system 200 may be configured to communicate with the processing system 100 of the contact center 20. Thus, the routing management system 200 may or may not be a part of the contact center 20.

As shown in FIG. 1, the customer profile database 210 and the agent profile database 220 are illustrated as parts of the routing management system 200. In other cases, the routing management system 200 may not include the customer profile database 210 and/or the agent profile database 220. In such cases, the routing management system 200 may be configured to communicate with the customer profile database 210 and the agent profile database 220, which may be parts of the contact center 20, or may be configured to communicate with the contact center 20. Also, in some cases, the customer profile database 210 and the agent profile database 220 may be integrated with the database(s) 104 of the contact center 20.

In some cases, the routing management system 200 may include an identity-and-access manager, or may be configured to communicate and/or integrate with an identity-and-access manager (e.g., a cloud-based identity and access management service such as Okta), to help secure and manage user authentication. In other cases, the identity-and-access manager may be separate from the routing management system 200. In such cases, the routing management system 200 may be configured to communicate with the identity-and access manager.

In some cases, the routing management system 200 may be a part of the contact center 20 (like that shown in FIG. 1). In other cases, the routing management system 200 may be configured to communicatively couple with the contact center 20.

It should be noted that any of the components (e.g., components 202, 204, 206, 210, 220, and any of other components mentioned herein) of the routing management system 200 may be implemented using hardware, software, or a combination of both. Also, two or more of the components (e.g., components 202, 204, 206, 210, 220, and any of other components mentioned herein) of the routing management system 200 may be combined or integrated as one processing unit. Furthermore, one or more of the components (e.g., components 202, 204, 206, 210, 220, and any of other components mentioned herein) may be implemented using a specialized processing unit that is unconventional in the sense that such specialized processing unit may include one or more processing features not present in a generic off-the-shelf computer.

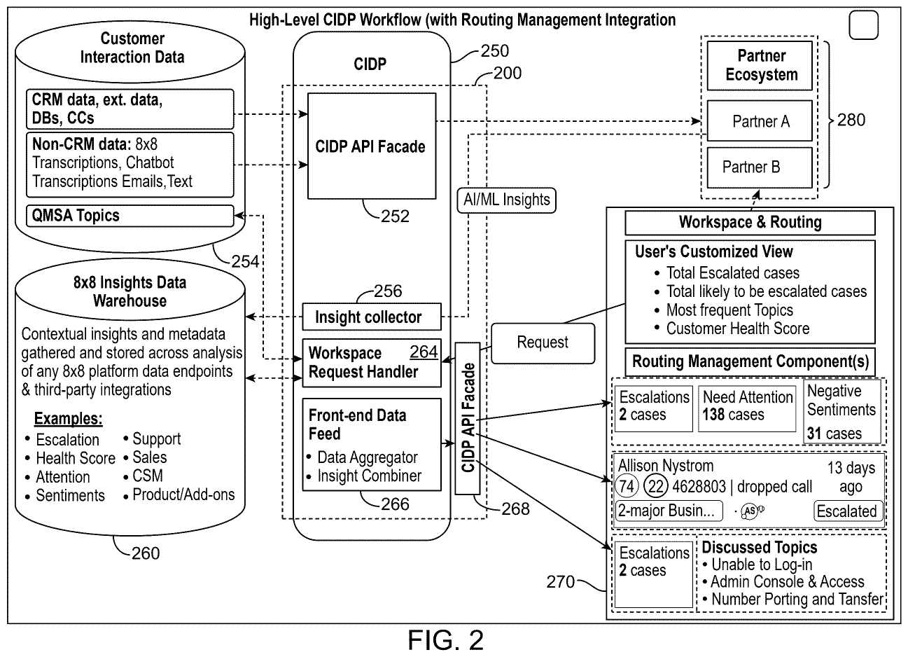

In some cases, the routing management system 200 may be implemented as a part of, or may be integrated with, a Customer Interaction Data Platform (CIDP). FIG. 2 illustrates an example of a Customer Interaction Data Platform (CIDP) 250 implemented in the contact center 20 of FIG. 1. The CIDP 250 includes a CIDP an API interface 252 interfacing with database 254 storing customer interaction data and partners 280 of the contact center 20. The partners 280 of the contact center 20 may provide human agent(s) and/or bot agent(s) for communication with customers of the contact center 20. The customers of the contact center 20 may include direct customers of the contact center 20 and/or indirect customers (e.g., customers of a third-party service that integrate with the contact center 20). The CIDP 250 also includes an insight collector 256 configured to communicate with a database 260 storing insight data provisioned and collected by the contact center 20. The insight data contain information regarding past and current communications between customers and agents. The insight collector 256 also communicates with the partners 280 of the contact center 20. The insight collector 256 is configured to provide insight data indicating insight of the communications to the partners 280, so that communication between agents of these partners 280 and customers 40 can be carried out and processed by the partners 280 (e.g., human agents and/or chatbot agents of the partners 280). In some cases, the database 254 and/or database 260 may be implemented as parts of the routing management system 200.

As shown in FIG. 2, the CIDP 250 also includes a workspace request handler 264 and a front-end data feed 266. The workspace request handler 264 is configured to receive a request from a user (e.g., an agent or a supervisor for a communication). In response to such request, the workspace request handler 264 then gathers the relevant information from the database 254 and the database 260, and passes the information to the front-end data feed 266. The front-end data feed 266 processes the information and provides the processed information through a CIDP API interface 268. In one implementation, the workspace request handler 264, the front-end data feed 266, and the CIDP API interface 268 may be parts of the user interface generator 206 in the routing management system 200. As shown in the figure, the CIDP API interface 268 may provide various information 270 regarding the communication, including but not limited to insights regarding the communication, insights about the customer 40, insights of agent in communication with the customer 40, insights of possible alternative agents to whom the communication can be routed for matter handling for the customer 40, etc. The information 270 may be presented in a user interface at a work station of an agent (e.g., human agent participating in the current communication, a routing operator, a supervisor of the communication, etc.). Alternatively, the information 270 may be presented in a user interface at a device of the customer 40, which allows the customer 40 to decide where to transfer the communication in a self-help configuration.

In some embodiments, the CIDP 250 is a unified, AI-powered system configured to provide a complete view of customer interactions across multiple channels (e.g., omni-channel) including voice, chat, email, social media, and networking. The CIDP 250 leverages real-time integration of interaction data with customer profiles, enabling smarter and more personalized experiences across the customer journey. In some cases, the CIDP 250 may provide an unified interaction and profile data layer, which combines real-time communications data (calls, chats, etc.) with customer data (CRM, purchase history) into a single, dynamic data layer, removing silos between channels and data sources. Also, in some cases, the CIDP 250 may provide streaming Architecture for Real-Time Insights. In such cases, the CIDP 250 may utilize a streaming data architecture to deliver actionable insights during live interactions, powering features like live sentiment analysis, intent detection, and next-best-action recommendations. Furthermore, in some cases, the CIDP 250 may provide cross-channel context persistence, wherein the CIDP 250 maintains full context across channels and sessions, so agents and AI systems can understand prior interactions regardless of where or when they occurred. In some cases, the CIDP 250 may provide or may utilize embedded AI for achieving interaction summarization and automation. In such cases, the CIDP 250 has/uses built-in generative AI tools configured to auto-summarize conversations, extract intent, and populate systems of record, thereby reducing agent workload and improving accuracy. Also, in some cases, the CIDP 250 may provide visual tools and analytics to map and optimize end-to-end customer journeys, using interaction metadata and customer outcomes for feedback loops. In further cases, the CIDP 250 may provide an extensible data fabric, which offers open APIs and pre-built connectors to CRMs, helpdesks, and analytics platforms, making it adaptable to diverse tech stacks without locking into proprietary ecosystems. It should be noted that the CIDP 250 is not limited to having the above features, and is not required to have all of the above features. In some cases, the CIDP 250 may have one, a combination, or all, of the above features.

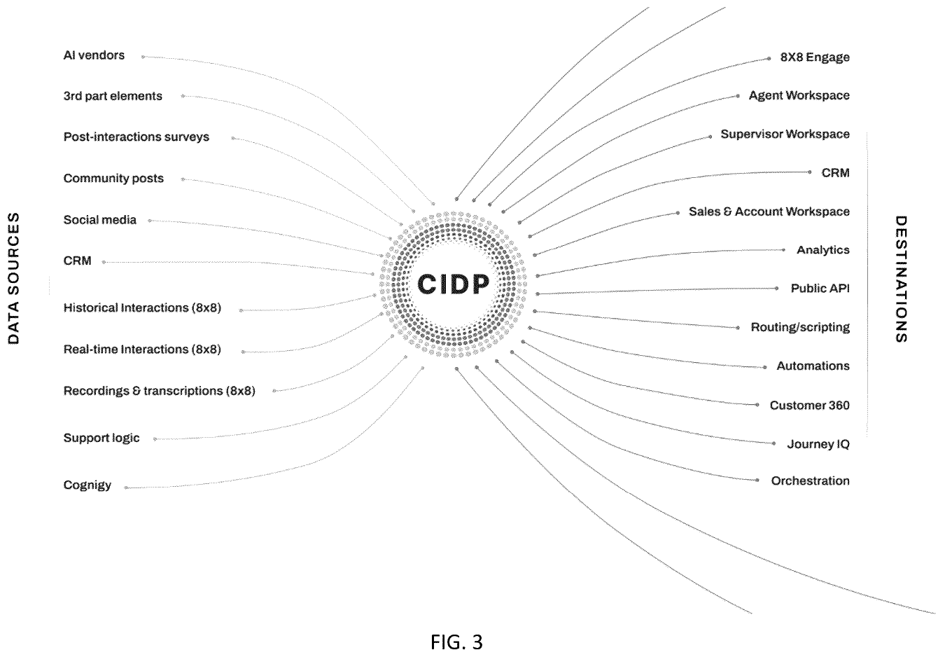

Because the contact center 20 interfaces and/or integrates with many data sources, a vast amount of datapoints (e.g., communication data, insights regarding the communication, insights regarding the customers, insights regarding agents participating in communications with customers, etc.) associated with such data sources may be collected and stored as customer interaction data in the database 254, and insight data in the database 260. The datapoints may be processed by the routing management system 200 to create customer profiles stored in the customer profile database 210, and agent profiles stored in the agent profile database 220. FIG. 3 illustrates an examples of data sources and services from which the CIDP 250 can obtain the vast amount of datapoints. Using these datapoints, the routing management system 200 can create insights of current and past communications, create customer profiles, create agent profiles, create training data set for training neural network models, generate routing information for assisting routing of communications, identify problem areas in communications, and create suggested actions for improving future communications.

As mentioned, the processing unit 202 of the routing management system 200 includes one or more neural network models 204. In some cases, a neural network model 204 may be configured (e.g., trained) to obtain communication data of a communication (current or past communication), and process the communication to obtain neural network model output. The neural network model output may be utilized by the routing management system 200 to determine routing information for routing a current communication. As will be described in detail below, in some cases, the routing information may include options for routing a communication to different agents, insights about the different agents, resolution confidences for the respective agents, or any combination of the foregoing. In other cases, a neural network model 204 may be configured (e.g., trained) to analyze a communication and determine a problem area of the communication, and/or to determine one or more suggested actions to improve the communication and/or future communications. In further cases, a neural network model 204 may be a bot, such as a customized bot trained in a specific area. In one implementation, the customized bot may be trained using input from a sales executive of a company having deal-specific insights gained from years of experience.

In some cases, the routing management system 200 may include multiple neural network models 204 trained in different area, and to provide different functions, for assisting communication routing and matter handling. For example, the routing management system 200 may include a first neural network model 204 trained to process communication data of a communication, and to output analytics indicating a state of the communication, routing suggestions for routing the communication, and/or insights regarding the routing suggestions. The routing management system 200 may optionally include a second neural network model 204 trained to detect problems in a communication, and to output suggested actions for improving current communication and/or future communications. The routing management system 200 may also optionally include a third neural network model 204 trained to provide a customized response to a customer of the communication based on input from the customer.

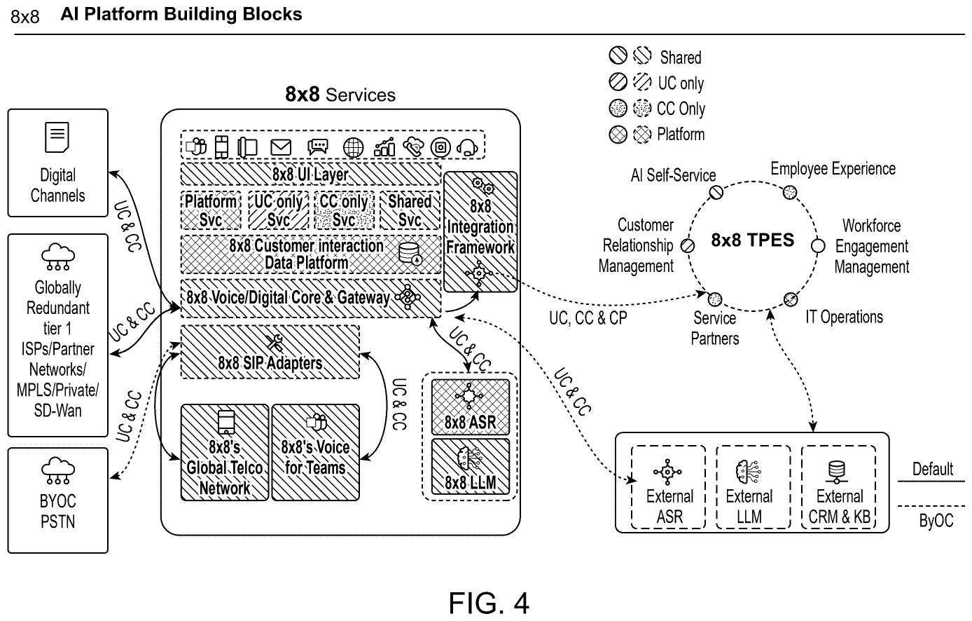

FIG. 4 illustrates an example of artificial intelligence (AI) building blocks for a communication platform implemented in the contact center 20 of FIG. 1. The neural network model(s) 204 may be trained based on a vast amount of datapoints generated and/or collected across the communication platform of the contact center 20. By means of non-limiting examples, the datapoints for training the neural network model(s) 104 may be generated and/or provisioned in association with services and features provided by different platforms, such as UCaaS, CCaaS, CPaaS, etc. The datapoints may be combined and labeled to create training data set for training one or more neural network models 104. Additional details regarding the neural network model(s) will be described below.

### Customer Profiles and Agent Profiles

FIG. 5 illustrates an example of a customer profile 500 that includes pertinent information such customer name, customer identifier, interaction history, current sentiment of customer in the current communication, current topic in current communication, topics of interest, feedback regarding agent interaction, communication preference, delivery preference, customer rating, tags, etc. It should be noted that the customer profile 500 is not limited to the examples of information shown, and that the customer profile 500 may have other information. For example, in some cases, the customer profile 500 may also include a language spoken by the customer, a location of the customer, an age of the customer, history of service provided by the contact center 20 (e.g., agents who provided support, customer account managers, customer success managers, etc. who have interacted with the customer), comments, notes, or two or more of any of the foregoing. Also, in other cases, the one or more of the examples of information may not be included in the customer profile 500.

In some cases, the user profile 500 may be created automatically by the routing management system 200 (or the CIDP of FIG. 2 of the routing management system 200 is integrated with the CIDP) whenever a new customer is detected in a communication. In one implementation, the processing unit 202 of the routing management system 200 may include a customer management system for managing (e.g., creating, updating, deleting, etc.) the customer profiles. For example, the routing management system 200 may analyze the communication to determine sentiment of the customer, topic of interest, communication preference, etc., or any of other information regarding the customer. Also, in some cases, the routing management system 200 may be configured to update the customer profile during a communication (as new insights about the communication surface), and/or after the communication.

In some cases, one or more items (contextual information in the customer profile 500) may be used by the routing management system 200 as a component for calculating a confidence scoring described herein. For example, if the routing management system 200 identifies an agent as a possible agent for handling matter for the customer 40, the routing management system 200 may access the topics of interest in the customer profile, and determine whether the agent's expertise matches with one of the topics of interest of the customer 40. If so, then the routing management system 200 may assign a higher confidence score for the suggested agent.

FIG. 6 illustrates an example of an agent profile 600 that includes pertinent information such as: agent name, agent identifier, area(s) of expertise, success rate, availability, rating, speed of issue resolution, etc. It should be noted that the agent profile 600 is not limited to the examples of information shown, and that the agent profile 600 may have other information. For example, in some cases, the agent profile 600 may also include a language spoken by the agent, a location of the agent, an age of the agent, history of service provided by the agent, a weakness of the agent, an interaction failure rate of the agent, comments, notes, or two or more of any of the foregoing. Also, in other cases, the one or more of the examples of information may not be included in the agent profile 600.

In some cases, the agent profile 600 may be created automatically by the routing management system 200 (or the CIDP of FIG. 2 of the routing management system 200 is integrated with the CIDP) whenever a new agent is detected in a communication. In one implementation, the processing unit 202 of the routing management system 200 may include a agent management system for managing (e.g., creating, updating, deleting, etc.) the agent profiles. For example, the routing management system 200 may analyze the communication to determine speed of resolution, current sentiment of customer communicating with the agent, topics being discussed, or any of other information regarding the agent. Also, in some cases, the routing management system 200 may be configured to update the agent profile during a communication (as new insights about the communication surface), and/or after the communication.

In some cases, the agent profile database 220 may store different agent profiles in different areas, such as sales, CSM, product, engineering, legal, software, Java, etc.

### User Interface Providing Routing Information

As discussed, the processing unit 202 of the routing management system 200 includes a user interface generator 206. The user interface generator 206 is configured to provide a user interface for presenting information to a user of the routing management system 200. Thue user may be a participant of the communication, such as the customer 40, or a human agent. Alternatively, the user may be a supervisor of the communication or a routing operator. In some cases, the user interface is a graphical user interface (GUI) having one or more GUI elements that allow the user to provide user input for influencing the routing of the communication.

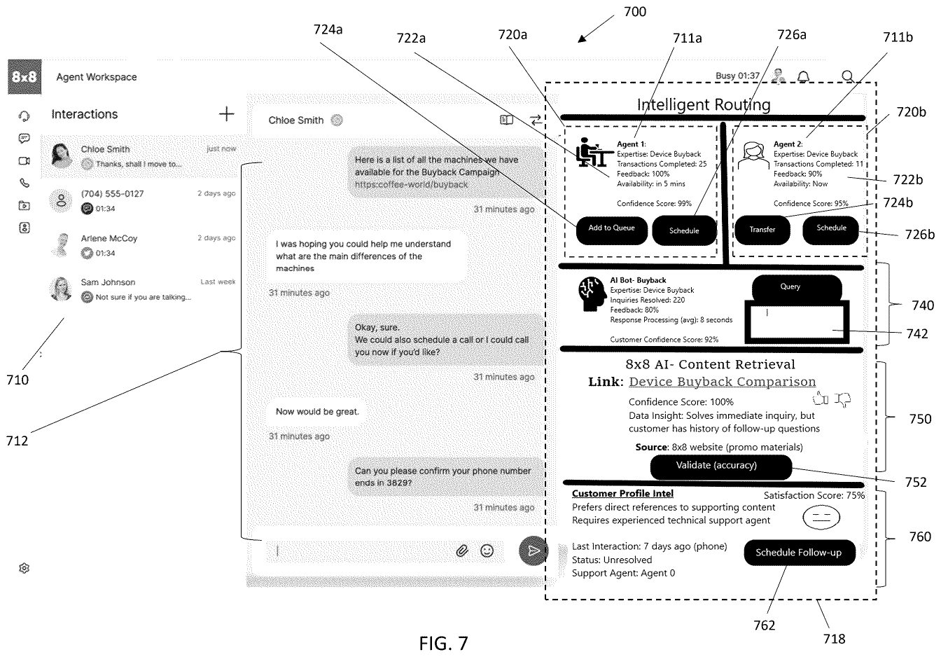

FIG. 7 illustrates an example or a user interface 700 generated by the user interface generator 206 of the routing management system 200. The user interface 700 provides contextual information for intelligent routing of network communication. As shown in the figure, the user interface 700 is provided at an agent station, which may be utilized by an agent of the communication, or a supervisor of the communication. The user interface 700 includes a summary 710 of previous communications with other agents, and a communication history 712 of the current communication. The communication history 712 of the current communication includes content (e.g., text messages) exchanged between customer 40 and the current agent (which may be a bot agent or a human agent).

In the illustrated example, the user interface 700 also includes routing information 718 to assist routing of the communication. The routing information 718 is generated by the processing unit 202 of the routing management system 200, and is provided by the user interface generator 206 for presentation in the user interface 700. The routing information 718 includes a first routing option 720a for routing the communication to a first agent, and a second routing option 720b for routing the communication to a second agent. The routing information 718 also includes a first identity 711a of the first agent, and a second identity 711b of the second agent. The routing information 718 further includes insights (metrics) 722a about the first agent in the first routing option 720a, and insights (metrics) 722b about the second agent in the second routing option 720b. In the illustrated example, the insights (metrics) 722a about the first agent include an expertise of the first agent, number of transactions completed (experience) by the first agent, feedback score for the first agent, availability of the first agent, and a confidence score of the first agent (indicating a likelihood of the first agent being able to resolve the issue for the customer 40). Similarly, the insights (metrics) 722b about the second agent include an expertise of the second agent, number of transactions completed (experience) by the second agent, feedback score for the second agent, availability of the second agent, and a confidence score of the second agent (indicating a likelihood of the second agent being able to resolve the issue for the customer 40).

In some cases, one or more items (contextual information in the customer profile 500) may be used by the routing management system 200 as a component for calculating the confidence score for each suggested agent. For example, if the routing management system 200 identifies an agent as a possible agent for handling matter for the customer 40, the routing management system 200 may access the topics of interest in the customer profile, and determine whether the agent's expertise matches with one of the topics of interest of the customer 40. If so, then the routing management system 200 may assign a higher confidence score for the suggested agent. Also, in some cases, a confidence score may be hyper-personalized. For example, the confidence score may be based on confidence that the agent can resolve the customer's need given the customer preferences (e.g., customer profile), historical successes by the agent, current accuracy of data (e.g., recency), etc.

In the illustrated example, the routing information 718 also includes a third routing option 740 that is a bot routing option or allowing the communication to be routed to a bot (e.g., chatbot). In some cases, the bot may be trained for a specific topic, may be trained for a specific department, and/or may be trained based on knowledge of a specific person. For example, the specific person may be a sales executive of a company having deal-specific insights gained from years of experience, and wherein the bot is trained based on the deal-specific insights. The bot routing option 740 includes insights (metrics) about the bot, such as area of expertise of the bot, number of inquiries resolved by the bot, feedback score (e.g., rating) of the bot, average response processing time of the bot, and customer confidence score (e.g., indicating likelihood of the bot resolving the issue for the customer) of the bot. The user interface 700 also includes a query field 742 for allowing the user to enter a query for the bot.

The routing information 718 also includes a content retrieval section 750 providing a link for resolving the issue raised by the customer 40 in the communication. The content retrieval section 750 also includes a confidence score for the link indicating a likelihood of the link resolving the issue for the customer 40, a source of the link, and insight about the link. The content retrieval section 750 also includes a GUI element 752 for allowing the user to validate the accuracy of the link, and/or the information presented in the link.

It should be noted that the information in the content retrieval section 750 to be provided to the customer 40 as answer is not limited to a link. In other cases, the information to be provided as answer to the customer 40 may be a text, a report, an attachment, etc. In some cases, information in the content retrieval section 750 may be obtained from an AI source (general AI modeling such as custom Chat GPT implementation trained based on contact center platform data, and/or from specifically trained AI modeling based on segmented information such as area of specialty), or from the Internet. The confidence score may indicate an accuracy of the answer, a likelihood that the answer satisfies the customer's inquiry, and/or a likelihood of a follow-up request. Also, in some cases, in response to the user selecting the GUI element 752, the routing management system 200 may validate (source attribution) answers provided using endpoints of the contact center 20. The routing management system 200 may perform primary confirmation of accuracy, and optionally a secondary confirmation of accuracy, and optionally, a tertiary confirmation of accuracy.

As shown in FIG. 7, the routing information 718 also includes customer information 760 indicating intel of the customer 40. In the illustrated example, the customer information 760 includes a satisfaction score of the customer 40 (indicating a satisfactory level of the customer 40 based on previous interactions with agent(s)), a response preference of the customer 40, an agent preference, last interaction time with the customer 40, and status of the current issue raised by the customer 40. One or more of these information may be obtained from the user profile of the customer 40, such as the example of the user profile described with reference to FIG. 5.

As shown in FIG. 7, the user interface 700 also includes a GUI element 762 for allowing the user to schedule a follow-up with the customer 40. If the user enters a user input to select the GUI element 762, the user interface 700 will provide a scheduler for allowing the user to schedule a time to follow up the communication with the customer 40. In some cases, the scheduler allows the follow up to be implemented using text messaging. In other cases, the scheduler allows the follow up to be implemented using email. In further cases, the scheduler allows the follow up to be implemented using a voice call. The scheduler may provide these as options for the user to select a method of the follow up.

Also, the routing information 718 that may be provided by the routing management system 200 via the user interface 700 is not limited to the examples. In other cases, the user interface 700 may provide other types of routing information. For example, in other cases, the routing information may optionally include a ranking of the first routing suggestion and the second routing suggestion. The ranking may be based on wait times for different agents associated respectively with the first routing suggestion and the second routing suggestion, based on feedback scores of different agents associated respectively with the first routing suggestion and the second routing suggestion, or based on other ranking parameter(s). Also, in other cases, the user interface 700 may not include one or more of the exemplary routing information 718 described above.

During use of the routing management system 200, the user (who may be a human agent involved in the communication with the customer 40, or a supervisor of the communication) is presented with the user interface 700 at the agent station. The user can see the communication history 712 involved with this particular customer 40. As the communication progresses, the communication history 712 is updated in real time (or close to real time). The routing management system 200 monitors the state of the communication and gathers routing information 718 based on the state of the communication for presentation at the user interface 700. Accordingly, as the communication progresses, the state of the communication changes, and the routing information 718 also changes. At the particular instant of the communication shown in the example, the routing management system 200 determines that the issue being discussed in the communication may be resolved by agent 1, or agent 2. The routing management system 200 accordingly provides the first routing option 720a for routing the communication to the first agent (agent 1), and the second routing option 720b for routing the communication to the second agent (agent 2). The user of the routing management system 200 may select one of these options by selecting the GUI element 724a or GUI element 724b. For example, the user may observe that agent 1 has more experience and is more likely to resolve the issue for the customer 40 in the communication than agent 2. However, the user may also observe that agent 1 has a longer wait time than agent 2. In some cases, the communication history 712 or the customer information 760 may indicate that the customer 40 prefers a more experienced agent and does not mind waiting. In such cases, the user may then select agent 1 for the customer 40, and may click on the GUI interface 724a. On the other hand, if the customer 40 prefers a more experienced agent and does not want to wait longer than 3 minutes, then the user may select agent 2 for the customer 40, or may select the follow up GUI element 762 to schedule the agent 1 to follow up with the customer 40 at a later time. In further cases, the customer 40 may prefer a bot response from a bot that is trained in the specific area of interest. In such cases, the user may select the routing option 740 to route the communication to the bot, or may enter a query on behalf of the customer 40 using the query field 742 to get a bot response for the customer 40. In other cases, the user may determine that the information in the content retrieval section 750 is the best option to help resolve issue with the customer 40 in the communication. In such cases, the user may provide such information to the customer 40 as a response in the communication, and the communication is not routed to agent 1, agent 2, nor the bot. Thus, as used in this specification, the term “routing information” may refer to any information that may be utilized to determine whether to route communication or not, and/or to determine which agent or next-step service to route the communication. In the alternative to, or in addition to, providing a response (e.g., answer), the routing management system 200 may also pass-on the customer 40 in the communication to a bot or a human agent (e.g., specialized in area of expertise that can help manage customer inquiries) selected by the user.

It should be noted that any of the exemplary routing information 718 described may be determined by the processing unit 202 of the routing management system 200. For example, the processing unit 202 may analyze the communication history and content thereof to determine the topic of communication. The processing unit 202 may also access the agent profile database 220 to select one or more agents (based on their areas of expertise, respective wait times, respective experiences, respective feedback scores, their respective confidence scores, or any combination of the foregoing) that are best suited for handling the topic of the communication. The processing unit 202 may also select a bot agent that is trained to handle the topic of communication, and present such bot agent as the routing option 740. In some cases, the determining of the routing information 718 for presentation in the user interface 700 may be performed at least partly by a neural network model (e.g., the neural network model 204) trained for such task. In one implementation, the neural network model may be trained based on past communication histories with different customers and agents, customer profiles of these customers, agent profiles of these agents, and metrics indicating success and failures of the past communications. In other cases, the determining of the routing information 718 may be performed without using any neural network model.

In the above example, the routing information 718 are described as being presented in the user interface 700 for use by an agent or a supervisor of the communication. In other cases, the user may be the customer 40 participating in the communication, and the user interface 700 may be provided to the customer 40.

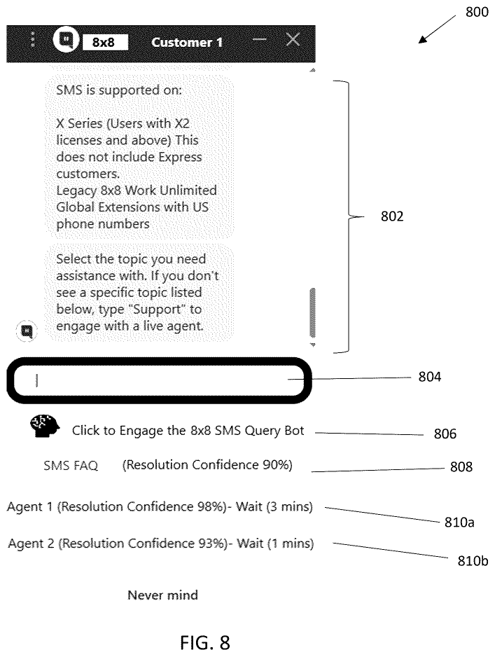

FIG. 8 illustrates another example or a user interface 800 providing contextual information for intelligent routing of communication between the customer 40 and an agent. The user interface 800 is illustrated as being configured for display at a screen of a handheld device (e.g., a mobile phone) of the customer 40. In other cases, the user interface 800 may be configured for display on a computer screen, like that described with reference to FIG. 7. As shown in FIG. 8, the user interface 800 is implemented as a self-service chat option for a customer (e.g., the customer 40). In the example shown, a customer is logged in as “Customer 1” and information in the corresponding customer profile (retrieved from the customer profile database 210) is analyzed relative to the context of the communication and available options (e.g., different possible agents to route the communicate based on agent profiles in the agent profile database 220) to resolve the customer inquiry.

In the illustrated example, the user interface 800 provides a chat history 802 for displaying content exchanged between the customer 40 and the current agent. The user interface 800 also includes a text input field 804 for allowing the customer 40 to enter text (e.g., text prompt, text query, etc.) for communication with current agent. In the illustrated example, the routing management system 200 determines that a 8×8 SMS Query Bot is a first routing option 806 for routing the current communication. The routing management system 200 also determines that the confidence (e.g., chance) 808 of the bot resolving the issue for the customer 40 is 90%. In addition, the routing management system 200 identifies two possible agents who can potentially resolve the issue for the customer 40 in the current communication, and presents them as respective second routing option 810a, and third routing option 810b. The first agent (Agent 1) has a resolution confidence of 98%, and a wait time of 3 minutes, and the second agent (Agent 2) has a resolution confidence of 93%, and await time of 1 minute.

The customer 40 may decide how the current communication is to progress based on the various routing information presented in the user interface 800. For example, if the customer 40 is in a hurry, and want to select a more available human agent, the customer 40 may select the third routing option 810b (e.g., by tapping on the GUI element corresponding to Agent 2) to cause the communication to be routed to Agent 2. On the other hand, if the customer 40 does not want to interact with any human agent, the customer 40 may select the first routing option 806 (e.g., by tapping on the GUI element corresponding to the SMS Query bot) to cause the communication to be routed to the SMS Query bot. In another scenario, if the customer 40 wants to select an agent who has the highest chance of resolving the issue, the customer 40 may select Agent 1 with the highest resolution confidence (e.g., by tapping on the GUI element corresponding to Agent 1) to cause the communication to be routed to Agent 2.

It should be noted that the routing information in the user interface 800 is not limited to the examples shown, and that the user interface 800 may present other routing information, such as any of those shown with reference to FIG. 7. For example, in other cases, the routing information may optionally include a ranking of the first routing suggestion and the second routing suggestion. The ranking may be based on wait times for different agents associated respectively with the first routing suggestion and the second routing suggestion, based on feedback scores of different agents associated respectively with the first routing suggestion and the second routing suggestion, or based on other ranking parameter(s). Also, in other cases, the user interface 800 may not include one or more of the exemplary routing information described above.

The various examples of routing information described herein are advantageous because they provide insights regarding possible agent(s) who can resolve the issue for the customer 40 in the current communication. Based on these insights, the user is better equipped to select the right path for advancing the communication, thereby increasing the chance that the issue will be resolved for the customer 40 and/or the chance that the issue will be handled by an agent in a manner (e.g., shorter wait time, no wait time, etc.) that suits the customer 40. Also, the user interface (e.g., user interface 700/800) described herein is advantageous because it provides the user various context-based options to advance the communication, thereby increasing the chance that the customer's inquiry will be successfully handled in accordance with the customer's preference.

The routing information has been described as including two routing options for routing the communication to two possible agents (e.g., human agents), and a routing option for routing the communication to a possible bot agent. In other cases, the routing information may include only two possible routing options for the user to select. The two routing options may be for routing the communication to a first human agent or a second human agent. Alternatively, the two routing options may be for routing the communication to a human agent or a bot agent. In further alternative, the two routing options may be for routing the communication to a first bot agent or a second bot agent. Thus, an agent to which the communication can be routed may be a human agent, or a bot agent.

Also, as used herein, the term “communication” may refer to a sending and/or receiving of information by one or two participants. For example, a communication may be an on-going communication in which the customer 40 and a current agent has exchanged information. In such cases, the routing information described herein allows the user to route the current communication (between the customer 40 and the current agent) to another agent. As another example, a communication may be a beginning of a conversation in which the customer 40 provisions content for transmission to a possible agent, but has not yet transmitted the content to any agent yet (or the content has been transmitted, but an agent has not yet been assigned to handle the communication). In such cases, the routing information describe herein allows the user to select an agent (e.g., first agent in the communication) for communication with the customer 40.

In the situation in which the routing suggested is from one agent to another agent, the routing suggestion for the communication may comprises an agent-to-agent transfer recommendation, an agent-to-bot transfer recommendation, a bot-to-agent transfer recommendation, or a bot-to-bot transfer recommendation. In some cases, the routing suggestion for the communication may include a recommendation to transfer from a first agent to a second agent, wherein the first agent and the second agent are in a same department, in different respective departments, in different respective companies, or may have different respective areas of expertise. Furthermore, the routing suggestion for the communication may include a recommendation to transfer the communication to a bot, wherein the bot is trained for a specific topic, is trained for a specific department, or is trained based on knowledge of a specific person. For example, the specific person may be a sales executive of a company having deal-specific insights gained from years of experience, and wherein the bot is trained based on the deal-specific insights. In further cases, the routing suggestion for the communication may include a recommendation to transfer the communication to a general AI-bot implemented across different types of data at a communication platform of a contact center (e.g., the contact center 20 of FIG. 1).

Also, as used in this specification, the term “routing” is not limited to transferring or connecting a communication with an agent (e.g., a human agent, a bot agent, etc.), and may refer to the action of taking a next step in furtherance of a communication. By means of non-limiting examples, “routing” may refer to accessing a service or a functionality (e.g., provided by a contact center, or a partner of the contact center), such as performing an Internet search, providing an inquiry answer, a validation of search result, a general chatbot service, a service of a customized chatbot, a follow-up feature, a scheduling of follow-up, etc. Accordingly, a routing suggestion may be a suggestion for any of these services or functionalities.

### Configuring Future Routing and/or Workflow Based on Data Insights

In some cases, the routing management system 200 may provide an agent with in-app update and data insights after the communication is completed. The routing management system 200 may also provide a GUI element for allowing the agent to take actions to affect future workflows so that future communications can be improved. In some cases, the routing management system 200 is implemented in, or is integrated with, an omni-channel platform of the contact center 20. Accordingly, datapoints associated with different services across the contact center 20, and meta data regarding the datapoints, can be leveraged to provide updates and insights across different services (e.g., features, functionalities), and to generate suggestions of actions for improving process flow of future communications. In some cases, the CIDP described with reference to FIG. 2 may be utilized to access the datapoints and meta data of the datapoints associated with different services across the contact center 20.

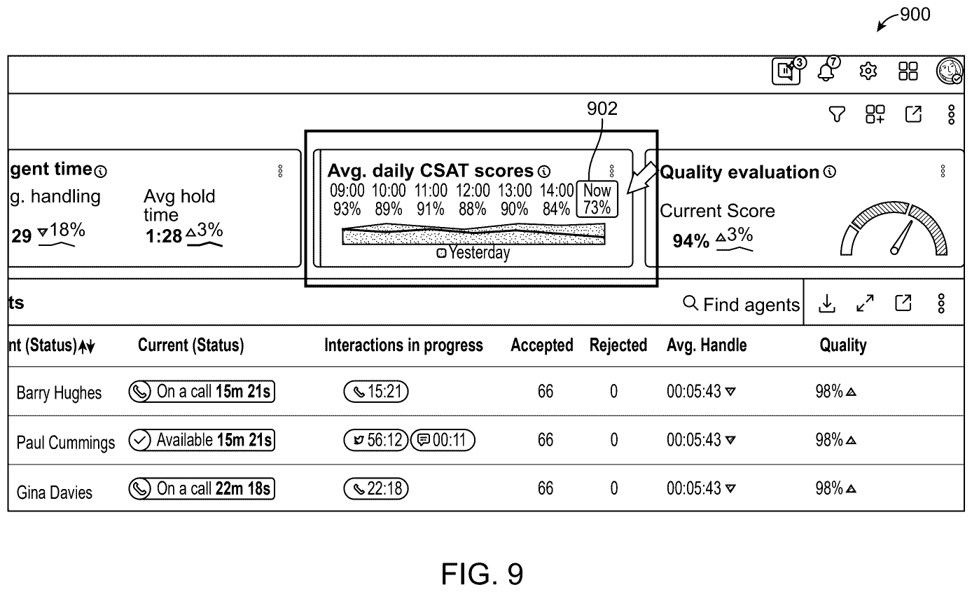

Consider an example where an agent was unable to resolve a matter and transferred/routed the customer 40 elsewhere without resolution. In such case, data (and metadata) from that customer interaction can be utilized to update platform analytics (e.g., agent analytics). The analytics may be provided to the agent or to any of other agents, who can further investigate the problem(s) with the past communication, and may take action to improve the processing flow for future communications. This example is further illustrated with reference to FIGS. 9-14.

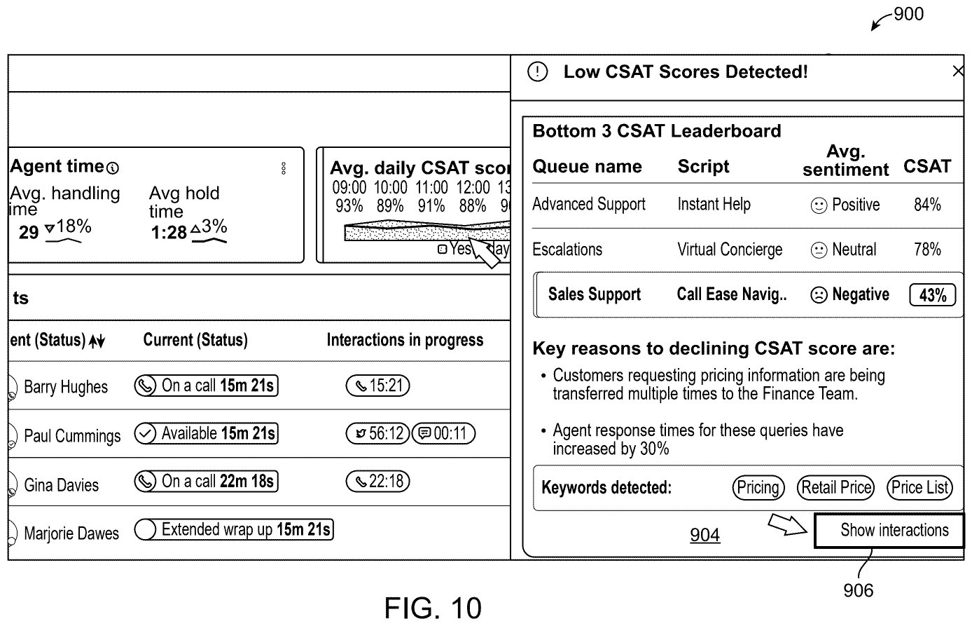

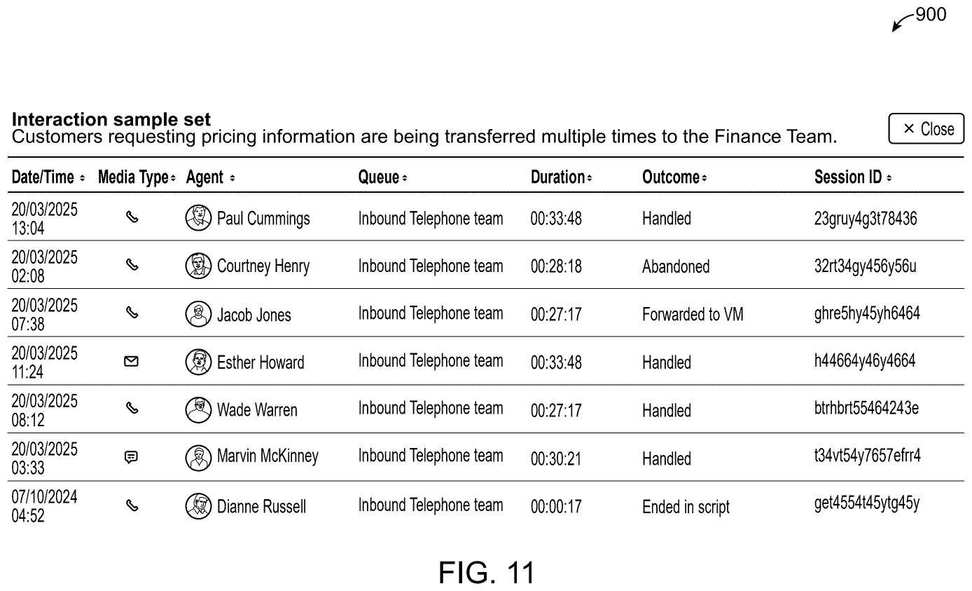

FIG. 9 illustrates an example of a user interface 900 presented at an agent workspace, particularly showing a real-time notification that a customer satisfaction (CSAT) score 902 is dropping. Via the user interface 900, the agent clicks on the feature (Avg. Daily CSAT scores), and sees generated contextual data insights 904 (shown in FIG. 10) surfaced to provide context as to why the CSAT scores 904 may be dropping. For example, the contextual data insights 904 may show pattern detected over multiple call communications. In other cases, the contextual data insights 904 may be for one specific customer communication instance. The agent may click on the GUI element 906 “Show interactions” to get specific interaction details. As a result, as shown in FIG. 11, a listing of recent customer communications which include details of a recently conducted call communication (e.g., that may have been routed but unresolved, or the case may have been resolved but routed numerous times (inefficient matter handling)).

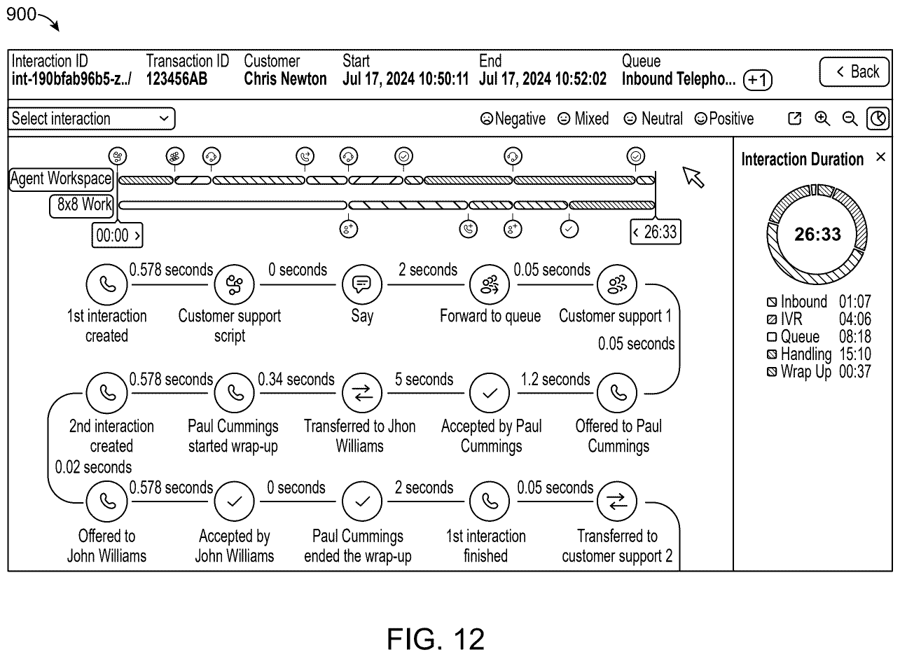

The agent may click on a specific case (one of the customer communications), and the user interface 900 will present interaction details of the selected case. For example, as shown in FIG. 12, the user interface 900 may provide an interactive visual timeline of the customer communication. The display of the timeline of events of the interaction is in response to the user selecting one of the communications in the list of communication of FIG. 11. The timeline of events for an interaction can be visually represented (e.g., color-coded) to show the processing flow for that past communication. The color-coded features allow the user to see where the interaction went smoothly, where there were bottlenecks, where there were trouble spots, where there were processing inefficiency, etc. As the agent reviews the timeline of events, the agent can click on and select where the bottlenecks or troubled spots are, to obtain further information about the interaction. In the illustrated example, the timeline of events shows that the customer initially contacted for help via IVR, and then was added to the customer support queue. The customer call was accepted and then routed to two different agents before receiving an answer.

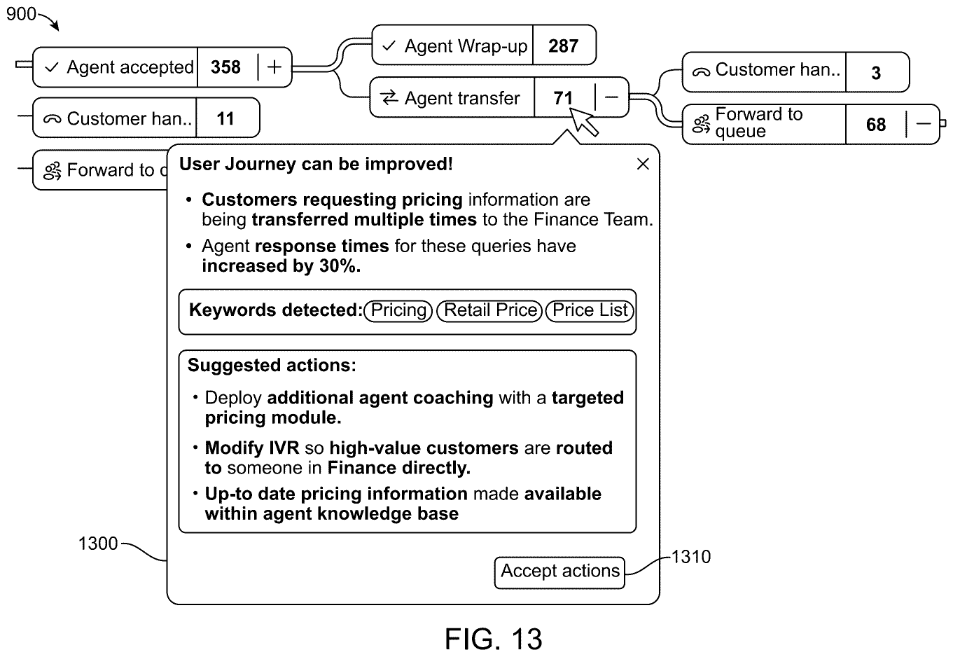

The user may observe that the inefficiency of the selected communication was due to too many transfers. Accordingly, the user may investigate the nature of the transfers occurred in the selected communication. As shown in FIG. 13, the user interface 900 may present data insights indicating the details of the transfer. In the illustrated example, the data insights show that the customer requested pricing information, and was transferred multiple times to the Finance Team. The user interface 900 also provides recommended actions for improving process flow of future communication involving the same or similar issue (e.g., where communication involves the same keywords detected, such as “pricing”, “retain price”, “price list”). In some cases, the agent may flag issue(s) and push an improved (suggested workflow) for application in future communications. As shown in the figure, the user interface 900 provides a suggestion 1300 of actions for improving workflow, and a graphical user interface (GUI) element 1310 “Accept actions” for allowing a user to accept the suggestion of actions. The suggestion 1300 of actions may be determined by the processing unit 202 of the routing management system 200. In one implementation, the processing unit 202 collects data insights regarding past communications, and analyzes the data insights to determine how future communications can be improved. In some cases, the neural network model 204 of the processing unit 202 may receive the data insights and may generate the suggestion 1300. In alternative cases, instead of, or in addition to, providing the suggestion 1300, the agent may provide a prompt to enter custom feedback (e.g., via text) for the contextual processing.

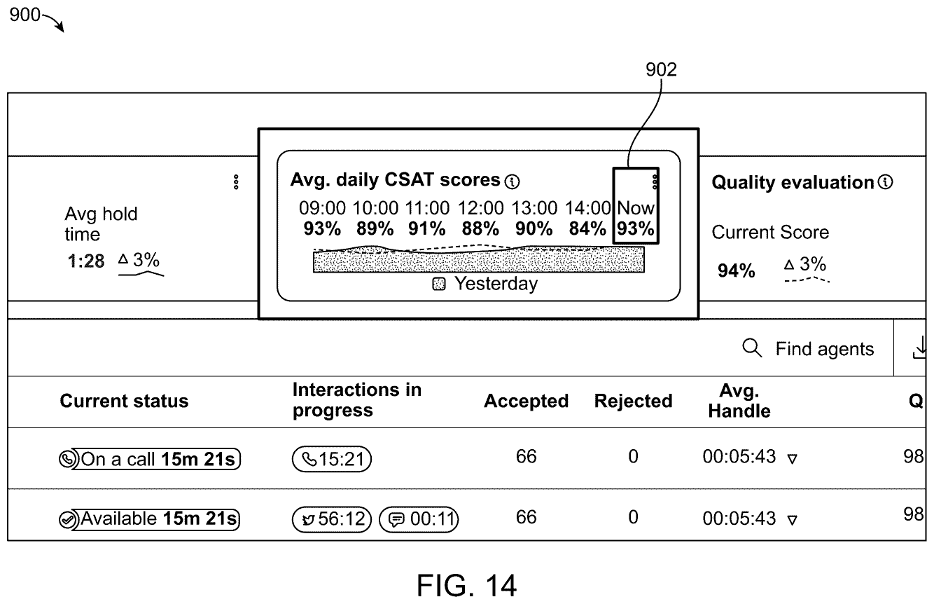

In the illustrated example shown in FIG. 13, the agent clicks on the GUI element 1310 to accept the suggested actions. As a result, the processing unit 202 of the routing management system 200 updates routing parameters so that future communications involving the same issue will be handled differently (i.e., based on the suggestion 1300 accepted by the agent). As shown in FIG. 14, after some time has passed (e.g., next day), the agent goes back in and can see an improved CSAT score 902 (avg. daily) after the improved workflow has been applied.

In further examples, the improved process flow for future communications may also be leveraged by the routing management system 200 to generate contextual data insights that can be surfaced in association with future agent/customer communications (e.g., as data insights for similar topics that may arise). The same feedback and improvement process described with reference to FIGS. 9-13 may be repeated to thereby continue to improve and refine the process flow for handling future communications involving the same issue.

In other cases, instead of using the analytics after the communication, the agent may access the analytics generated in real-time during the communication with the customer 40. In either case, data insights provided by the routing management system 200 may be leveraged to improve the overall journey of users of the contact center 20.

It should be noted that the user interface 900 is not limited to presenting the example of information described above, and that the user interface 900 may provide other information and/or features for allowing a user to gain insights of communications, and to implement action(s) for improving communications based on the insights. For example, in some cases, the user interface 900 may allow a user to create customized prompts for context-specific interaction with customers, and for provisioning data insights and analytics that can be surfaced to agents and/or customers.

As shown in the above examples with reference to FIGS. 9-14, the user interface 900 providing the analytics is advantageous because it can be utilized to improve customer experience, improve workflow processing, diagnose trouble areas in a communication, and/or improve efficiency of matter handling. The accessing of the analytics and the action for improving communication can be done asynchronous to the communication (e.g., before or after the communication). However, in other cases, the accessing of the analytics and the action for improving communication may also occur during the communication. For example, in some cases, during a communication, the analytics regarding the communication may indicate that there is a problem with the communication. For example, the analytics may indicate that the customer 40 has been transferred too many times, that the customer 40 has been in communication for a long duration, that the customer 40 is frustrated (based on sentiment detected in the content of the communication), etc. In such cases, the routing management system 200 may provide a notification to the agent handling the communication. The notification may include the analytics of the communication, and may also include suggested actions for improving the communication.

### Method

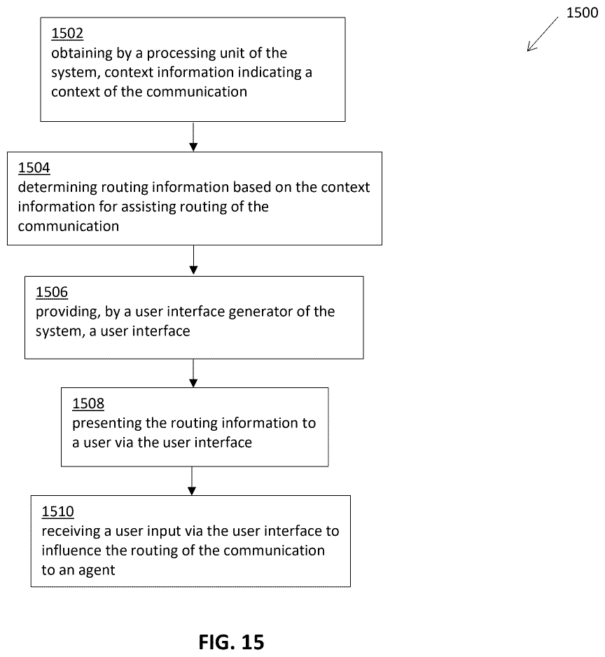

FIG. 15 illustrates a method 1500 in accordance with some embodiments. In some cases, the method 1500 may be performed by the routing management system 200 described with reference to FIG. 1. In other cases, the method 1500 may be performed by other system(s). For example, in some cases, the method 1500 may be performed by a system integrated with a communication platform for assisting a routing of a communication. The communication platform may be implemented in a contact center, or may be communicatively coupled with the contact center. Also, in some cases, the method 1500 may be performed by a communication platform that is configured to provide, or to enable, communication between customers and agents. The method 1500 includes: obtaining by a processing unit of the system, context information indicating a context of the communication (item 1502); determining routing information based on the context information for assisting routing of the communication (item 1504); providing, by a user interface generator of the system, a user interface (item 1506); presenting the routing information to a user via the user interface (item 1508); and receiving a user input via the user interface to influence the routing of the communication to an agent (item 1510).

Optionally, the method 1500 further includes provisioning a routing output to cause the courting of the communication to the agent based on the user input.

Optionally, in the method 1500, the agent is a bot.

Optionally, in the method 1500, the agent is a human agent.

Optionally, in the method 1500, the communication is a network conversation between a customer and a chatbot.

Optionally, in the method 1500, the communication is a network conversation between a customer and a human agent.

Optionally, in the method 1500, the routing information comprises a routing suggestion for the communication.

Optionally, in the method 1500, the routing suggestion for the communication comprises an agent-to-agent transfer recommendation, an agent-to-bot transfer recommendation, a bot-to-agent transfer recommendation, or a bot-to-bot transfer recommendation.

Optionally, in the method 1500, the routing suggestion is based on the communication and the context of the communication.

Optionally, in the method 1500, the routing suggestion is based on a customer profile of a participant of the communication.

Optionally, in the method 1500, the routing suggestion is based on an agent profile of the agent.

Optionally, in the method 1500, the routing suggestion for the communication comprises a recommendation to transfer from a first agent to a second agent, wherein the first agent and the second agent are in a same department, in different respective departments, or in different respective companies.

Optionally, in the method 1500, the routing suggestion for the communication comprises a recommendation to transfer the communication to a bot, wherein the bot is trained for a specific topic, is trained for a specific department, or is trained based on knowledge of a specific person.

Optionally, in the method 1500, the specific person is a sales executive of a company having deal-specific insights gained from years of experience, and wherein the bot is trained based on the deal-specific insights.

Optionally, in the method 1500, the routing suggestion for the communication comprises a recommendation to transfer the communication to a general AI-bot implemented across different types of data at a communication platform of a contact center.

Optionally, in the method 1500, the routing information comprises a first routing suggestion.

Optionally, in the method 1500, the routing information also comprises a first identity of a first agent associated with the first routing suggestion.

Optionally, in the method 1500, the routing information also comprises first agent information indicating an expertise of the first agent, an experience of the first agent, a success rate of the first agent, an availability of the first agent, a location of the first agent, a language spoken by the first agent, a wait time for the first agent, or any combination of two or more of any of the foregoing.

Optionally, in the method 1500, the routing information also comprises a second routing suggestion.

Optionally, in the method 1500, the routing information also comprises a first identity of a first agent associated with the first routing suggestion, and a second identity of a second agent associated with the second routing suggestion.

Optionally, in the method 1500, the routing information also comprises a ranking of the first routing suggestion and the second routing suggestion.

Optionally, in the method 1500, the ranking is based on wait times for different agents associated respectively with the first routing suggestion and the second routing suggestion.

Optionally, in the method 1500, the ranking is based on feedback scores of different agents associated respectively with the first routing suggestion and the second routing suggestion.

Optionally, the method 1500 further includes accessing a customer database storing a customer profile, and wherein the context information comprises or is based on one or more items in the customer profile.

Optionally, in the method 1500, one or more items in the customer profile comprise a preference of a customer, current sentiment of the customer, past communication history of the customer, satisfaction score, a language spoken by the customer, a location of the customer, an age of the customer, one or more subjects of interest of the customer, or two or more of any of the foregoing.

Optionally, the method 1500 further includes accessing an agent database storing an agent profile, and wherein the context information comprises or is based on one or more items in the agent profile.

Optionally, in the method 1500, the one or more items in the agent profile comprise agent information indicating an expertise of the agent, an experience of the agent, a strength of the agent, a weakness of the agent, an interaction success rate of the agent, an interaction failure rate of the agent, or any combination of two or more of any of the foregoing.

Optionally, in the method 1500, the user is a participant of the communication, and wherein the user interface is configured to present the routing information to the participant of the communication.

Optionally, in the method 1500, the user interface generator is configured to provide the user interface to the participant of the communication as a self-service feature.

Optionally, in the method 1500, the user interface generator is configured to provide the user interface as a part or, or in association with, a communication interface that allows the user to communicate with a chatbot or a human agent.

Optionally, in the method 1500, the user is a routing operator, and wherein the user interface is configured to present the routing information to the routing operator.

Optionally, in the method 1500, the user is a supervisor of the communication, and wherein the user interface is configured to present the routing information to the supervisor.

Optionally, in the method 1500, the user interface includes a follow-up feature for allowing the user to schedule a follow-up communication at a future time.

Optionally, the method 1500 further includes accessing a customer profile and an agent profile, and scheduling the follow-up communication based on the customer profile and the agent profile.

Optionally, the method 1500 further includes providing a follow-up message, a follow-up call, or a follow-up email, as the follow-up communication.

Optionally, the method 1500 further includes creating customized prompts for context-specific interaction in the communication.

Optionally, the method 1500 further includes providing the customized prompts to the user and/or to a current agent involved in the communication.

Optionally, in the method 1500, the communication platform is a component of a contact center.

Optionally, in the method 1500, the communication platform is an omni-channel communication platform of the contact center, and wherein the processing unit comprises a neural network model trained based on data points across the omni-channel platform.

Optionally, in the method 1500, the data points are associated with data sources integrated with the omni-channel communication platform of the contact center.

Optionally, in the method 1500, the processing unit comprises a neural network model implemented as a part of a contact center.

Optionally, in the method 1500, the neural network model is trained to analyze data endpoints of contact center to generate a customized response, and wherein the method comprises providing the customized response.

Optionally, in the method 1500, the endpoints data comprise device-specific data, user-specific data, application-specific data, service-specific data, third-party specific data, or any combination of two or more of the foregoing.

Optionally, in the method 1500, the customized response comprises a bot response.

Optionally, in the method 1500, the neural network model comprises a bot trained for a specific topic, trained for a specific department, or trained based on knowledge of a specific person.

Optionally, in the method 1500, the specific person is a sales executive of a company having deal-specific insights gained from years of experience, and wherein the bot is trained based on the deal-specific insights.

Optionally, in the method 1500, the neural network model is trained to analyze data endpoints of contact center to generate a routing suggestion for the communication, and wherein the method comprises providing the routing suggestion.

Optionally, in the method 1500, the neural network model is configured to generate a report based on endpoints of data sources integrated with a contact center, and wherein the method comprises providing the report.

Optionally, in the method 1500, the report comprises a communication summary, a meeting summary, a text-to-speech file, a translation, a transcription, a user profile, an agent profile, or two or more of any combination of the foregoing.

Optionally, in the method 1500, the neural network model is trained based on past interactions between customers and agents.

Optionally, in the method 1500, the past interactions comprise positive past interactions, negative past interactions, or a combination of both the positive past interactions and the negative past interactions.

Optionally, the method 1500 further includes providing, by the processing unit or the neural network model of the processing unit, an interactive routing of the communication for matter handling.

Optionally, in the method 1500, the interactive routing is based on a health score.

Optionally, in the method 1500, the health score is based on an experience with a specific customer, and wherein the processing unit is configured to route the communication to a specific customer support manager based on the health score.

Optionally, in the method 1500, the health score is matter specific, customer specific, agent specific, organization specific, or any combination of two or more of the foregoing.

Optionally, in the method 1500, the health score is an overall score regarding the communication, regarding a specific agent, or regarding a communication platform providing the communication.

Optionally, in the method 1500, the communication platform is configured to assist matter handling for one or more customers, and wherein the health score is a real-time or near real-time evaluation of performance of the communication platform.

Optionally, in the method 1500, the neural network model is trained based on a skillset of an agent.

Optionally, in the method 1500, the agent comprises an Unified Communication (UC) agent, a Contact Center (CC) agent, a Communication Platform as a Service (CPaaS) agent, or any of other cloud-based platform agents.

Optionally, in the method 1500, the network model is based on sales profiles, agent profiles, CSM profiles, product profiles, engineering profiles, legal profiles, or two or more of any of the foregoing.

Optionally, the method 1500 further includes providing, by the processing unit or the neural network model of the processing unit, a response to a customer as a part of the communication; wherein the method further comprises providing, by the processing unit or the neural network, a confidence score that the response is accurate, a source attribution for the response, a confidence score that the response satisfies a customer inquiry, a confidence score that response is complete, a likelihood of a follow-up request associated with the response, a validation of the response, or two or more of any combination of the foregoing.

Optionally, the method 1500 further includes providing, by the processing unit or the neural network of the processing unit, a predictive insight regarding the communication.

Optionally, the method 1500 further includes providing, by the processing unit or the neural network of the processing unit, a confidence scoring for a suggested routing to the agent.

Optionally, the method 1500 may be implemented using a product having a non-transitory medium storing a set of instructions, wherein an execution of the instructions will cause the method 1500 to be performed. The method 1500 implemented using the product includes: obtaining by a processing unit of the system, context information indicating a context of the communication; determining routing information based on the context information for assisting routing of the communication; providing, by a user interface generator of the system, a user interface; presenting the routing information to a user via the user interface; and receiving a user input via the user interface to influence the routing of the communication to an agent. In some cases, the set of instructions may include instructions for obtaining context information indicating a context of the communication; instructions for determining routing information based on the context information for assisting routing of the communication; instructions for providing a user interface; presenting the routing information to a user via the user interface; and instructions for receiving a user input via the user interface to influence the routing of the communication to an agent. Optionally, the set of instructions may include instructions for provisioning a routing output to cause the courting of the communication to the agent based on the user input. Optionally, the set of instructions may include instructions for accessing an agent database storing an agent profile, and wherein the context information comprises or is based on one or more items in the agent profile. Optionally, the set of instructions may include instructions for accessing a customer profile and an agent profile, and scheduling the follow-up communication based on the customer profile and the agent profile. Optionally, the set of instructions may include instructions for providing a follow-up message, a follow-up call, or a follow-up email, as the follow-up communication. Optionally, the set of instructions may include instructions for creating customized prompts for context-specific interaction in the communication. Optionally, the set of instructions may include instructions for providing the customized prompts to the user and/or to a current agent involved in the communication. Optionally, the set of instructions may include instructions for providing, by the processing unit or the neural network model of the processing unit, an interactive routing of the communication for matter handling. Optionally, the set of instructions may include instructions for providing, by the processing unit or the neural network model of the processing unit, a response to a customer as a part of the communication; and instructions for providing, by the processing unit or the neural network, a confidence score that the response is accurate, a source attribution for the response, a confidence score that the response satisfies a customer inquiry, a confidence score that response is complete, a likelihood of a follow-up request associated with the response, a validation of the response, or two or more of any combination of the foregoing. Optionally, the set of instructions may include instructions for providing, by the processing unit or the neural network of the processing unit, a predictive insight regarding the communication. Optionally, the set of instructions may include instructions for providing, by the processing unit or the neural network of the processing unit, a confidence scoring for a suggested routing to the agent.

### Neural Network Model(s)

Moreover, aspects of the present disclosure are directed to systems and methods that implement one or more neural network models (e.g., the neural network model 204). By means of non-limiting examples, the neural network model 204 may be trained artificial intelligence (AI), machine learning (ML), etc. The neural network model 204 may implement, or may be at least a part of the system 100. In some cases, the neural network model 204 may be a part of the routing management system 200 described herein. In other cases, the neural network model 204 may be in communication with the system 100 or the routing management system 200. The neural network model 204 may be a part of the contact center 20, or may be separate from the contact center 20.

In some cases, the neural network model 204 may be configured to receive and use one or more of a variety of data involved in network traffic flow of communication (between customer 40 and agent(s)) as input, perform analysis based on such data to monitor a state of the communication, and provide output based on the analysis. The output from the neural network model 204 may be insight data regarding the current and/or predicted state of the communication (e.g., between the customer 40 and an agent), and/or insight data regarding the current and/or predicted state of one or more services involved with the communication. In some cases, the output from the neural network model 204 may include routing suggestions to route the communication to different agents, and metrics regarding the different suggestions (such as wait time to reach agent for each suggestion, success rate for each suggested agent, etc.). The routing suggestions and/or their respective metrics may be based on context of the communication, such as one or more items in a customer profile, one or more items in an agent profile, communication data of the communication, information regarding the communication, or any combination of the foregoing. Thus, in some cases, any of these information may be used by the routing management system 200 to provide a context to influence AI-driven communication between the customer 400 and one or more agents. In other cases, the output from the neural network model 204 may be provided as input automatically to control a routing of communication, so that a communication routing can be automatically executed.

In some cases, the neural network model 204 may provide neural network processing to further contemplate various types of signal data that may be collected through various host applications/services (e.g., pertaining to a software communications platform). In some cases, the neural network model 204 may identify an issue with the communication (such as a potential issue with a service involved with network traffic data) based on such signal data. For instance, application of trained AI/ML processing (e.g., one or more trained machine learning models) may be adapted to evaluate network traffic processed by an exemplary software platform (e.g., software communications platform such as 8×8 Work®), and/or network traffic to and/or from third party service providers. Contextual data can be derived from any data point individually or in aggregation including historical signal data or current signal data (e.g., an ongoing communication between customer 40 and agent). For example, historical signal data collected using a software communications platform, including from prior user communications, can be combined with current user-specific signal data, device-specific signal data, etc., prior, during or after an electronic communication, to generate and surface contextually relevant data insights for a user (e.g., customer 40, a supervisor of the communication involving the customer 40, a current agent involved with the communication, etc.). This unique and comprehensive analysis of big data managed through a software communications platform enables provision of rich and contextually relevant data insights tailored for a specific purpose (e.g., to determine insights regarding an on-going communication, to determine routing recommendation for routing the current communication to another agent, to determine context for assisting routing of the current communication, etc.). Exemplary signal data analysis can further be utilized to yield determinations as to how (and/or when) to generate updated analytics (in real-time or near real-time) and/or reporting, as well as when and how often to present data insights and/or suggestions (e.g., suggestions for routing communication to different agents). In further examples, signal data can be analyzed to determine the next steps or actions (e.g., provide routing suggestion, determine insights of communication, schedule follow-up action, etc.) to be performed to continue communication and user engagement across a plurality of communication channels of a software communications platform (e.g., omni-channel communication experience). Non-limiting examples of signal data that may be collected and analyzed includes but is not limited to: device-specific signal data collected from operation of one or more user computing devices; user-specific signal data collected from specific tenants/user-accounts with respect to access to any of: devices, login to a distributed software platform, applications, services, etc. ; application-specific data collected from usage of applications/services and associated endpoints (including third-party endpoints integrated within a software platform), data collected from disparate software platforms that provide disparate types of access characteristics; data collected from data flow architecture including integrated service (e.g., bots) in a software communications platform, or a combination thereof. Analysis of such types of signal data in an aggregate manner may be useful in helping generate contextually relevant determinations, data insights, etc. Analysis of exemplary signal data may comprise identifying correlations and relationships between different types of signal data specific to user usage of one or more software data platforms (e.g., software communications platforms), where target users may be developers, engineers, end users, or customers, and where telemetric analysis may be applied to generate determinations with respect to a contextual state of any type of user activity with respect to different host application/services and associated endpoints at any point in time (historic, current, or predictive of future). Analysis of signal data, including user-specific signal data, should occur in compliance with user privacy regulations and policies.

In some examples, one or more components are configured to manage application of one or more AI models to enhance processing described in the present disclosure. Trained AI processing is applicable to aid any type of determinative or predictive processing including specific processing operations described with respect to determinations, classification ranking/scoring and relevance ranking/scoring. An exemplary component for implementation trained AI processing may manage AI modeling including the creation, training, application, and updating of AI, ML modeling. Trained AI processing may be adapted to execute specific determinations described herein including those for analyzing specific data and data sources of a software data platform (e.g., a software communications platform) and/or generating insights for management of data flows, GUI feature functionality, or data augmentation. For instance, an AI model may be specifically trained and adapted for execution of processing operations pertaining to analyzing features and functionality of a software communications platform including those non-limiting examples described herein. Non-limiting examples of AI implementation including but are not limited to: analyzing data (and metadata) associated with one or more software platforms including third-party integrations of features/functionalities; analyzing data of past, current or scheduled communications, among other examples.

In one example, trained AI processing comprises a hybrid AI model (e.g., hybrid machine learning model, neural network model) that is adapted and trained to execute a plurality of processing operations described in the present disclosure. In alternative examples, trained AI processing comprises a collective application of a plurality of trained AI models (e.g., 3 trained AI models) that are separately trained and managed to execute processing described herein. In alternative examples, the present disclosure extends to integrating third-party AI modeling and further adapting and customizing said AI modeling to work with specific data and data sources of an exemplary software platform. For example, a third-party AI model may be adapted to work within a software communications platform including data, data sources, and integrations (e.g., APIs, web hooks, etc.) related to features and functionality provided (or extending capabilities) of a software communications platform. In examples where a plurality of independently trained and managed AI models is implemented, downstream processing efficiency may be improved by an ordered application of trained AI models where processing results from earlier applied AI models can be propagated to subsequently applied AI models. For example, a trained AI model may evaluate accesses, seeds, pinecones, indicators, external influences, weighting and the like, and derive data correlations to improve processing and efficiency. This may be utilized to adjust weighting and/or assessed risk levels based on the evaluations.

Non-limiting examples of supervised learning that may be applied comprise but are not limited to: nearest neighbor processing; naive Bayes classification processing; decision trees; linear regression; support vector machines (SVM) neural networks (e.g., convolutional neural network (CNN) or recurrent neural network (RNN)); and transformers, among other examples. Non-limiting examples of unsupervised learning that may be applied comprise but are not limited to: application of clustering processing including k-means for clustering problems, hierarchical clustering, mixture modeling, etc.; application of association rule learning; application of latent variable modeling; anomaly detection; and neural network processing, among other examples. Non-limiting examples of semi-supervised learning that may be applied comprise but are not limited to: assumption determination processing; generative modeling; low-density separation processing and graph-based method processing, among other examples. Non-limiting examples of reinforcement learning that may be applied comprise but are not limited to: value-based processing; policy-based processing; and model-based processing, among other examples. Furthermore, a component for implementation of trained AI processing may be configured to apply a ranker to generate relevance scoring to assist with any processing determinations with respect to any relevance analysis, such as that described herein. Scoring for relevance (or importance) ranking may be based on individual relevance scoring metrics described herein or an aggregation of said scoring metrics. In some examples where multiple relevance scoring metrics are utilized, a weighting may be applied that prioritizes one relevance scoring metric over another depending on the signal data collected and the specific determination being generated. Results of a relevance analysis may be finalized according to developer specifications. This may comprise a threshold analysis of results, where a threshold relevance score may be comparatively evaluated with one or more relevance scoring metrics generated from application of trained AI/ML processing.

Further, aspects may integrate AI/ML modeling to correlate large volumes of data in a contextually relevant manner. This can be used not only for generation (and adaptation) of scoring for types of data to surface for assisting routing of communication, but also generation of decision points (e.g., alerting, access control, next steps, omni-channel engagement) as well as generation of data insights/suggestions, reporting, generation of knowledge base, support content, data processing flow configuration recommendations (e.g., recommendation to rout communication to different agents). In addition to broad applicability, approaches according to the present disclosure can be implemented as a scalable solution (e.g., a solution for a company in several different use cases are built (such as department-specific or user group-specific) to more effectively manage a software platform (e.g. communications software platform).

As an example, one or more ML/AI models may be generated, trained and adapted to analyze context of current communication between customer 40 and an agent, for example, to identify a frustration of the customer 40, an inefficiency of an agent in communication with the customer 40, an inability for the agent to resolve the customer's request, etc.

In additional examples, AI/ML modeling may be built, trained, and adapted to manage insight generation and layers of abstraction including ranking and relevance. For instance, contextual analysis of data interactions relative to the plurality of data endpoints for an exemplary software communications platform can selectively generate insights specific to interested parties (such as participant, e.g., customer 40, of a current communication, a supervisor of the communication, a routing operator, etc.) data insights that are specific to end users, and data insights, that are specific to others including third-party vendors. Generated insights can be ranked for relevance and propagated accordingly for one or more interested parties, for example, aligning with organizational specifications. For example, in some cases, an insight may be generated for a service provider to address a potential issue with a communication involved with customer 40 and an agent of the service provider. In such cases, the service provider may want to utilize the routing management system 200 described herein to address the potential issue. In some cases, the routing management system 200 may assist the service provider by routing the communication to another agent of the service provider, or to another agent of a different service provider.

In other cases, the neural network model 204 may be configured to provide at least a par of a response to the customer 40 in response to the customer's inquiry in the communication. For example, the neural network model 204 may be a bot configured (e.g., trained) to analyze data endpoints of contact center to generate a customized response. The customized response may be a bot response provided to the customer 40 as a response to the customer's inquiry in the communication. By means of non-limiting examples, the endpoints data may comprise device-specific data, user-specific data, application-specific data, service-specific data, third-party specific data, or any combination of two or more of the foregoing. In some cases, the neural network model 204 may comprise a bot trained for a specific topic, trained for a specific department, or trained based on knowledge of a specific person. For example, the specific person is a sales executive of a company having deal-specific insights gained from years of experience, and wherein the bot is trained based on the deal-specific insights.

Optionally, the neural network model 204 may also be configured to provide one or more metrics relating to the response generated by the neural network model 204. By means of non-limiting examples, the metric(s) may be a confidence score that the response is accurate, a source attribution for the response, a confidence score that the response satisfies a customer inquiry, a confidence score that response is complete, a likelihood of a follow-up request associated with the response, a validation of the response, or two or more of any combination of the foregoing.

Also, in some cases, the neural network model may optionally be configured to generate a report based on endpoints of data sources integrated with a contact center. By means of non-limiting examples, the report may comprises a communication summary, a meeting summary, a text-to-speech file, a translation, a transcription, a user profile, an agent profile, or two or more of any combination of the foregoing.

In some cases, the neural network model 204 may be trained based on data points across a communication platform (e.g., omni-channel platform) of a contact center. The data points may be associated with data sources integrated with the omni-channel communication platform of the contact center. In one implementation, the neural network model 204 may be trained based on past interactions between customers and agents. The past interactions may comprise positive past interactions, negative past interactions, or a combination of both the positive past interactions and the negative past interactions.

### Specialized Processing System

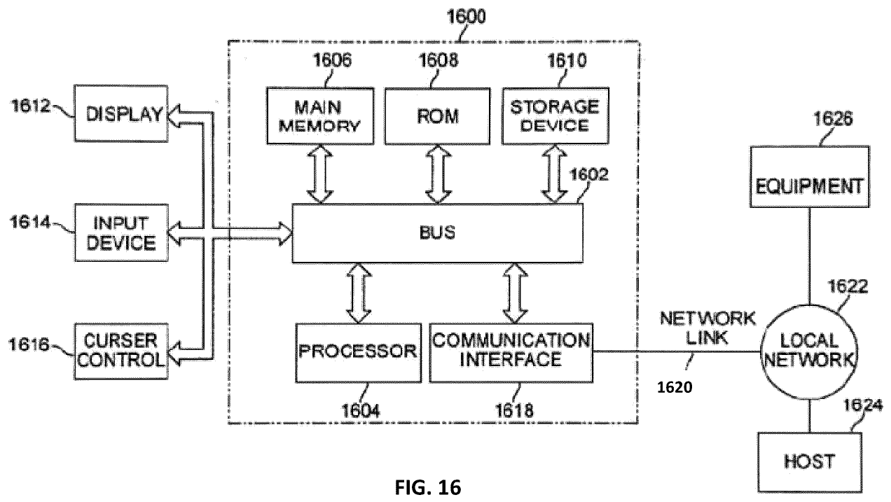

FIG. 16 illustrates a specialized processing system 1600 for implementing one or more features described herein. For examples, the processing system 1600 may implement the system 100, or one or more components of the system 100 (such as the routing management system 200).

Processing system 1600 includes a bus 1602 or other communication mechanism for communicating information, and a processor 1604 coupled with the bus 1602 for processing information. The processor system 1600 also includes a main memory 1606, such as a random access memory (RAM) or other dynamic storage device, coupled to the bus 1602 for storing information and instructions to be executed by the processor 1604. The main memory 1606 also may be used for storing temporary variables or other intermediate information during execution of instructions to be executed by the processor 1604. The processor system 1600 further includes a read only memory (ROM) 1608 or other static storage device coupled to the bus 1602 for storing static information and instructions for the processor 1604. A data storage device 1610, such as a magnetic disk or optical disk, is provided and coupled to the bus 1602 for storing information and instructions.

The processor system 1600 may be coupled via the bus 1602 to a display 1612, such as a screen or a flat panel, for displaying information to a user. An input device 1614, including alphanumeric and other keys, or a touchscreen, and/or any of other data capture devices (sensors), is coupled to the bus 1602 for communicating information and command selections to processor 1604. Another type of user input device is cursor control 1616, such as a 2D touchpad, a touchscreen, a trackball, or cursor direction keys for communicating direction information and command selections to processor 1604 and/or for controlling cursor movement on display 1612. This input device typically has two degrees of freedom in two axes, a first axis (e.g., x) and a second axis (e.g., y), that allows the device to specify positions in a plane. The input device 1614 and/or the cursor control device 1616 may be the same device in some embodiments. Also, the input device 1614 and/or the cursor control device 1616 may be any 2D input device or 3D input device.

In some embodiments, the processor system 1600 can be used to perform various functions described herein. According to some embodiments, such use is provided by processor system 1600 in response to processor 1604 executing one or more sequences of one or more instructions contained in the main memory 1606. Those skilled in the art will know how to prepare such instructions based on the functions and methods described herein. Such instructions may be read into the main memory 1606 from another processor-readable medium, such as storage device 1610. Execution of the sequences of instructions contained in the main memory 1606 causes the processor 1604 to perform the process steps described herein. One or more processors in a multi-processing arrangement may also be employed to execute the sequences of instructions contained in the main memory 1606. In alternative embodiments, hard-wired circuitry may be used in place of or in combination with software instructions to implement the various embodiments described herein. Thus, embodiments are not limited to any specific combination of hardware circuitry and software.

The term “processor-readable medium” as used herein refers to any medium that participates in providing instructions to the processor 1604 for execution. Such a medium may take many forms, including but not limited to, non-volatile media, volatile media, and transmission media. Non-volatile media includes, for example, optical or magnetic disks, SD disks, such as the storage device 1610. A non-volatile medium may be considered an example of non-transitory medium. Volatile media includes dynamic memory, such as the main memory 1606. A volatile medium may be considered an example of non-transitory medium. Transmission media includes cables, wire and fiber optics, including the wires that comprise the bus 1602. Transmission media can also take the form of acoustic or light waves, such as those generated during radio wave and infrared data communications.

Common forms of processor-readable media include, for example, hard disk, a magnetic medium, a CD-ROM, any other optical medium, a RAM, a PROM, and EPROM, a FLASH-EPROM, any other memory chip or cartridge, a carrier wave as described hereinafter, or any other medium from which a processor can read.

Various forms of processor-readable media may be involved in carrying one or more sequences of one or more instructions to the processor 1604 for execution. For example, the instructions may initially be carried on a storage of a remote computer or remote device. The remote computer or device can send the instructions over a network, such as the Internet. A receiving unit local to the processing system 1600 can receive the data from the network, and provide the data on the bus 1602. The bus 1602 carries the data to the main memory 1606, from which the processor 1604 retrieves and executes the instructions. The instructions received by the main memory 1606 may optionally be stored on the storage device 1610 either before or after execution by the processor 1604.

The processing system 1600 also includes a communication interface 1618 coupled to the bus 1602. The communication interface 1618 provides a two-way data communication coupling to a network link 1620 that is connected to a local network 1622. For example, the communication interface 1618 may be an integrated services digital network (ISDN) card to provide a data communication. As another example, the communication interface 1618 may be a local area network (LAN) card to provide a data communication connection to a compatible LAN. Wireless links may also be implemented. In any such implementation, the communication interface 1618 sends and receives electrical, electromagnetic or optical signals that carry data streams representing various types of information.

The network link 1620 typically provides data communication through one or more networks to other devices. For example, the network link 1620 may provide a connection through local network 1622 to a host computer 1624 or to equipment 1626. The data streams transported over the network link 1620 can comprise electrical, electromagnetic or optical signals. The signals through the various networks and the signals on the network link 1620 and through the communication interface 1618, which carry data to and from the processing system 1600, are exemplary forms of carrier waves transporting the information. The processing system 1600 can send messages and receive data, including program code, through the network(s), the network link 1620, and the communication interface 1618.

In some cases, the processing system 1600 may be configured as a specialized processing system using instructions and/or programming language to cause electronic components of the processing system 1600 to behave in certain unique manner in order to provide one or more technical features described herein.

### Cloud-Based Platform Implementation

It should be noted that the system 100 (e.g., the routing management system 200) and/or the contact center 20 described herein may be implemented as, or may be a part of, any platform(s), such as one or more cloud-based platforms. By means of non-limiting examples, the one or more cloud-based platforms may include an Unified Communications as a Service (UCaas) platform, a Control Center as a Service (CCaas) platform, a Communications Platform as a Service (CPaas), or any combination of two or more of the foregoing.

UCaaS is a cloud-based solution that integrates various communication tools and services, including voice calls, video conferencing, messaging, and collaboration features into a single platform. It aims to simplify and unify communications within an organization, enabling employees to connect seamlessly across different devices and locations. UCaaS platforms may provide tools for voice over IP (VoIP), instant messaging, file sharing, video calls, and even presence management. By leveraging the cloud, businesses can scale their communication infrastructure without needing on-premise hardware, and remote or hybrid teams can communicate as easily as if they were in the same office.

CCaaS refers to a cloud-based platform that provides businesses with the tools to manage and optimize their customer service and support operations. It may include features like automatic call distribution (ACD), interactive voice response (IVR), call recording, omnichannel support (electronic meetings, voice, chat, email, messaging, digital messaging, social media), and analytics. CCaaS solutions are designed to improve customer experiences by streamlining communication with support agents and offering deeper insights into customer interactions. They also allow organizations to scale their contact centers efficiently, adapting to peak periods or shifting team sizes. This service is particularly beneficial for businesses with high customer interaction volumes, such as retail, finance, and telecom.

CPaaS is a cloud-based service that provides developers with the tools and APIs to integrate real-time communication capabilities into their own applications, websites, or workflows. Unlike UCaaS and CCaaS, which are pre-built solutions, CPaaS offers a flexible, customizable platform that can be tailored to the specific needs of an organization. With CPaaS, businesses can embed voice, video, messaging, and even chatbots into their applications without having to build complex communication infrastructure from scratch. This makes CPaaS ideal for organizations looking to create bespoke customer engagement solutions or integrate communication features into existing platforms, such as e-commerce websites or CRM systems.

In other cases, the system 200 and/or the contact center 20 described herein may be implemented as, or may be a part of, other types of cloud-based platforms, such as a Customer Experience as a Service (CXaaS) platform, an Infrastructure-as-a-Service (IaaS) platform, Platform-as-a-Service (PaaS), a Software-as-a-Service (SaaS) platform, or Anything-as-a-Service (xPaas) platform.

CXaaS is a cloud-based model that provides businesses with on-demand tools and services to manage and enhance their customer experience (CX) across various touchpoints. It integrates a wide range of solutions—such as customer service platforms, analytics, feedback management, and communication channels—into a unified service offering. CXaaS allows organizations to deliver personalized, omnichannel experiences for customers without having to invest in complex, on-premise systems. By leveraging cloud technology, businesses can easily scale their CX capabilities, gain insights from data analytics, and continuously improve interactions with customers, ultimately boosting satisfaction and loyalty. CXaaS empowers companies to respond more agilely to changing customer expectations while reducing the overhead of maintaining and upgrading traditional customer experience infrastructure.

IaaS is a cloud computing model that provides virtualized computing resources over the internet, such as servers, storage, networking, and other infrastructure components, on a pay-as-you-go basis. Instead of investing in and maintaining physical hardware, businesses can rent infrastructure from a cloud service provider, allowing them to scale resources up or down based on demand. IaaS offers flexibility, cost-efficiency, and the ability to focus on application development and business operations rather than IT management. With IaaS, businesses can deploy and manage applications without the need for physical data centers, significantly reducing capital expenditures and operational complexity.

PaaS is a cloud computing model that provides a comprehensive platform allowing developers to build, deploy, and manage applications without needing to manage the underlying infrastructure. It offers a set of tools, frameworks, and services—such as databases, development environments, and middleware—built on top of IaaS (Infrastructure-as-a-Service), enabling businesses to focus on writing code and developing functionality rather than worrying about the hardware, network, or operating system. PaaS platforms typically support multiple programming languages and integrate with various third-party services, allowing for greater flexibility and speed in application development. By abstracting away infrastructure concerns, PaaS empowers developers to innovate and scale applications quickly, improving productivity and reducing time-to-market for new features or products.

SaaS is a cloud computing model that delivers software applications over the internet on a subscription or pay-as-you-go basis, eliminating the need for businesses to install, maintain, or update software on their own servers or devices. With SaaS, users can access applications from any device with an internet connection, typically through a web browser, making it highly convenient and scalable. SaaS providers handle all aspects of the software, including updates, security, and infrastructure management, freeing businesses from the complexities of software maintenance. This model is particularly advantageous for businesses because it reduces upfront costs, supports remote collaboration, and ensures that users are always using the most up-to-date version of the software. xPaaS is an expansive cloud service model that offers a wide range of customizable, on-demand capabilities across various domains, such as infrastructure, software, and platforms, enabling businesses to access specialized services without the need for extensive on-site management. Unlike traditional cloud models like IaaS, PaaS, or SaaS, xPaaS can encompass almost any type of service or functionality a business may require, from data analytics and artificial intelligence to security, IoT, and application deployment. This flexibility allows organizations to tailor solutions to their unique needs, scale resources dynamically, and innovate faster while minimizing upfront costs and complexity. xPaaS simplifies operations by providing a unified, cloud-based platform for diverse business functions, making it an appealing option for organizations seeking agility and cost efficiency in a rapidly changing digital landscape.

### Definitions

As used in this specification, the term “product” may refer to any human-made and/or machine-made article/item. By means of non-limiting examples, the product may be an electronic device, a hardware and/or software component of an electronic device, an application in a cloud/server, etc.

As used in this specification, the term “contact center” refers to any communication system or component(s) thereof, which handles communications between or among parties via phone, SMS, email, web, cloud, social media, or any combination of the foregoing, wherein a party may be a customer, an organization, a chatbot, or any of other types of entity that is capable of communicating with an individual.

In addition, as used in this specification, the term “neural network model” refers to any computing unit, system, or module made up of a number of interconnected processing elements, which process information by their dynamic state response to input. In some embodiments, the neural network model may have deep learning capability, machine learning capability, and/or artificial intelligence. In some embodiments, the neural network model may be simply any computing element that can be trained using one or more data sets. Also, in some embodiments, the neural network model may be any type of neural network. By means of non-limiting examples, the neural network model may be a perceptron, a feedforward neural network, a radial basis neural network, a deep-feed forward neural network, a recurrent neural network, a long/short term memory neural network, a gated recurrent unit, an auto encoder neural network, a variational auto encoder neural network, a denoising auto encoder neural network, a sparse auto encoder neural network, a Markov chain neural network, a Hopfield neural network, a Boltzmann machine, a restricted Boltzmann machine, a deep belief network, a convolutional network, a deconvolutional network, a deep convolutional inverse graphics network, a generative adversarial network, a liquid state machine, an extreme learning machine, an echo state network, a deep residual network, a Kohonen network, a support vector machine, a neural turing machine, a modular neural network, a sequence-to-sequence model, etc., or any combination of the foregoing.

In addition, as used in this specification, the term “model” may refer to one or more algorithms, one or more equations, one or more processing applications, one or more variables, one or more criteria, one or more parameters, or any combination of two or more of the foregoing. Also, the term “model” may in some embodiments cover machine learning model (such as neural network model), or components thereof, such as layers, interconnections weights, or any combination of the foregoing.

Also, as used in this specification, the term “machine learning model” may refer to any processing entity (e.g., module, application, program, processing architecture, etc.) that has machine learning capability and/or that is configured by machine learning. Neural network model is an example of machine learning model, and therefore, the term “machine learning model” is not limited to neural network model.

Also, as used in this specification, the term “signal” may refer to one or more signals. By means of non-limiting examples, a signal may include one or more data, one or more information, one or more signal values, one or more discrete values, etc.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications and equivalents.

What is claimed:

1. A system integrated with a communication platform for assisting a routing of a communication, comprising:
a processing unit configured to
obtain context information indicating a context of the communication, and
determine routing information based on the context information for assisting routing of the communication, wherein the routing information comprises a first routing suggestion for the communication;
wherein system also comprises a user interface generator configured to provide a user interface, the user interface configured to present the routing information to a user, wherein the user interface is configured to receive a user input to influence the routing of the communication to an agent.

2. The system of claim 1, wherein the first routing suggestion for the communication comprises an agent-to-agent transfer recommendation, an agent-to-bot transfer recommendation, a bot-to-agent transfer recommendation, or a bot-to-bot transfer recommendation.

3. The system of claim 1, wherein the first routing suggestion is based on a customer profile of a participant of the communication, and/or an agent profile of the agent.

4. The system of claim 1, wherein the first routing suggestion for the communication comprises a recommendation to transfer the communication to a bot, wherein the bot is trained for a specific topic, is trained for a specific department, or is trained based on knowledge of a specific person.

5. The system of claim 4, wherein the specific person is a sales executive of a company having deal-specific insights gained from years of experience, and wherein the bot is trained based on the deal-specific insights.

6. The system of claim 1, wherein the first routing suggestion for the communication comprises a recommendation to transfer the communication to a general AI-bot implemented across different types of data at a communication platform of a contact center.

7. The system of claim 1, wherein the routing information also comprises a first identity of a first agent associated with the first routing suggestion.

8. The system of claim 7, wherein the routing information also comprises first agent information indicating an expertise of the first agent, an experience of the first agent, a success rate of the first agent, an availability of the first agent, a location of the first agent, a language spoken by the first agent, a wait time for the first agent, or any combination of two or more of any of the foregoing.

9. The system of claim 1, wherein the routing information also comprises a second routing suggestion.

10. The system of claim 9, wherein the routing information also comprises a first identity of a first agent associated with the first routing suggestion, and a second identity of a second agent associated with the second routing suggestion.

11. The system of claim 9, wherein the routing information also comprises a ranking of the first routing suggestion and the second routing suggestion.

12. The system of claim 11, wherein the ranking is based on wait times for different agents associated respectively with the first routing suggestion and the second routing suggestion.

13. The system of claim 11, wherein the ranking is based on feedback scores of different agents associated respectively with the first routing suggestion and the second routing suggestion.

14. The system of claim 1, further comprising a customer database storing a customer profile, wherein the context information comprises or is based on one or more items in the customer profile, and wherein one or more items in the customer profile comprise a preference of a customer, current sentiment of the customer, past communication history of the customer, satisfaction score, a language spoken by the customer, a location of the customer, an age of the customer, one or more subjects of interest of the customer, or two or more of any of the foregoing.

15. The system of claim 1, further comprising an agent database storing an agent profile, wherein the context information comprises or is based on one or more items in the agent profile, and wherein the one or more items in the agent profile comprise agent information indicating an expertise of the agent, an experience of the agent, a strength of the agent, a weakness of the agent, an interaction success rate of the agent, an interaction failure rate of the agent, or any combination of two or more of any of the foregoing.

16. The system of claim 1, wherein the user is a participant of the communication, and wherein the user interface is configured to present the routing information to the participant of the communication.

17. The system of claim 1, wherein the user interface includes a follow-up feature for allowing the user to schedule a follow-up communication at a future time, and wherein the system is configured to access a customer profile and an agent profile, and to schedule the follow-up communication based on the customer profile and the agent profile.

18. The system of claim 1, wherein the communication platform is an omni-channel communication platform of a contact center, and wherein the processing unit comprises a neural network model trained based on data points across the omni-channel platform, wherein the data points are associated with data sources integrated with the omni-channel communication platform of the contact center.

19. A method performed by a system integrated with a communication platform for assisting a routing of a communication, the method comprising:
obtaining, by a processing unit of the system, context information indicating a context of the communication;
determining routing information based on the context information for assisting routing of the communication, wherein the routing information comprises a first routing suggestion for the communication;
providing, by a user interface generator of the system, a user interface;
presenting the routing information to a user via the user interface; and
receiving a user input via the user interface to influence the routing of the communication to an agent.

20. A computer-product comprising a non-transitory medium storing instructions, wherein an execution of the instructions will cause a method to be performed by a system integrated with a communication platform for assisting a routing of a communication, the method comprising:
obtaining, by a processing unit of the system, context information indicating a context of the communication;
determining routing information based on the context information for assisting routing of the communication, wherein the routing information comprises a first routing suggestion for the communication;
providing, by a user interface generator of the system, a user interface;
presenting the routing information to a user via the user interface; and
receiving a user input via the user interface to influence the routing of the communication to an agent.
